(19) United States
(12) Patent Application Publication
(10) Pub. No.: US 2020/0210593 A1
(43) Pub. Date: Jul. 2, 2020

(54) PERSONAL DATA HUB SYSTEM

(71) Applicants: Paul R. Goldberg, Palo Alto, CA (US); Frances M. Goldberg, Palo Alto, CA (US)

(72) Inventors: Paul R. Goldberg, Palo Alto, CA (US); Frances M. Goldberg, Palo Alto, CA (US)

(21) Appl. No.: 16/525,239

(22) Filed: Jul. 29, 2019

Related U.S. Application Data
(63) Continuation-in-part of application No. 16/236,467, filed on Dec. 29, 2018.

(51) Int. Cl. G06F 21/60; G06N 5/04; H04L 29/08

(52) U.S. Cl. CPC G06F 21/60; H04L 67/306; H04L 67/36; G06N 5/04

(57) ABSTRACT

The present invention provides an apparatus, method, and system for an entity to receive an inference or profile of characteristics that has been generated from personal or non-personal data related to an individual, where the inference or profile of characteristics has been provisioned to the entity by command of the individual. The provisioning of an inference or profile of characteristics related to the individual by the direct action of the individual, serves as explicit permission for the entity to employ the individual's inference or profile of characteristics for the advancement of the entity's business interests. With most, if not all, data privacy regimes requiring the prior explicit consent of an individual for an entity to use the individual's personal or non-personal data, either for internal or external purposes, the present invention can significantly ease the burden on an entity associated with meeting the compliance requirements mandated by regulations in the governmental jurisdictions in which they may, or do, operate.

### CROSS REFERENCE TO RELATED APPLICATIONS

This application is a continuation-in-part of co-pending U.S. Non-Provisional application Ser. No. 16/236,467 filed Dec. 29, 2018.

### BACKGROUND OF INVENTION

### 1. Field of Invention

The field of invention is compliance processing. In particular, the present invention relates to the processing of data to provide it with attributes that allow it to comply with regulations enforced in a governmental jurisdiction.

### 2. Discussion of Related Art

Today commercial, financial, political, health care, and religious entities, to name just a few, collect and use massive amount of personal and non-personal data to further their business interests. Data collected from and on individuals, who either directly or indirectly interact with these entities, are used by the collecting entity, and often by entities affiliated with the collecting entity, to facilitate consumer behavioral targeting or profiling. A growing portion of the data is collected by means of one or more connected devices used by individuals. The data is communicated to one or more entities who may sell the data to generate a revenue stream, analyze the data and use the analysis results to communicate targeted messages to those individuals, or analyze the data and use the analysis results to profile those individuals in order to include or exclude groups of individuals who display certain characteristics from offers, opportunities, or future interaction. Individuals whose data are collected are most often unaware that their data is being collected, have no way of preventing their data from being collected if they so choose, do not know all the entities collecting their data, and have no say as to how their data is being used once it is collected.

Government jurisdictions around the world have become concerned about the widespread use of the portion of this data that is considered personal to the individuals from which it was collected. In response to this concern they have enacted, and continue to enact, regulations to protect the privacy of these individuals, as well as to give these individuals a say in whether or not they want their data collected, and how and by whom their data is used once it is collected. A first of such privacy regulations is the “EU Regulation 2016/679 of the European Parliament and of the Council of 27 Apr. 2016 On The Protection Of Natural Persons With Regard To The Processing Of Personal Data And On The Free Movement Of Such Data, And Repealing Directive 95/46/EC”. It came into effect in the European Union on May 25, 2018. This regulation is commonly referred to as the “General Data Protection Regulation” or GDPR. A second of such privacy regulations was passed by the California legislature on Jun. 28, 2018. It is the “2018 California Consumer Privacy Act” or CCPA, which will go into effect on Jan. 1, 2020. This regulation, like the GDPR, grants an individual a right to request a business to disclose the categories and specific pieces of personal information that it collects about the individual, the categories of sources from which that information is collected, the business purposes for collecting or selling the information, and the categories of 3rd parties with which the information is shared. Although it has much in common with the GDPR, its stated definitions and detailed requirements are significantly different. One very important difference between the GDPR and the CCPA is the definition of “personal information” in the CCPA and the definition of “personal data” in the GDPR. In the CCPA's definition of personal information, information that is publicly available, or that is de-identified, is not included in “personal information”, while in the GDPR's definition of “personal data” it is. These conflicting definitions will place a heavy burden on entities that seek to be in compliance with both regulations. They will need to spend costly personnel, capital equipment, and legal resources to separate collected data into the categories of ‘personal data’, ‘personal information’, ‘non-personal data’, ‘personal information that is publicly available’, and ‘personal information that has been de-identified’, and thereafter verify that such separation meets the requirements of each regulation. As the number of conflicting government privacy regulations increase, entities faced with the need to comply with multiple privacy regimes may find the ongoing costs associated with such compliance untenable.

Therefore, there is a need for a technology that provides entities with a source of personal or non-personal data related to individuals who they directly or indirectly interact with, that meets compliance requirements mandated by regulations in the governmental jurisdictions in which they operate.

### SUMMARY OF INVENTION

The present invention addresses the need outlined above by use of an apparatus, to be hereafter referred to as a “Personal Data Hub” or PDH, under the control of an individual. Such apparatus acquires personal and non-personal data from one or more network connected devices used by the individual by use of a “Network Communication Interface” or NCI, stores the acquired data in a “Data Storage Unit” or DSU, and generates an inference or profile of characteristics that relates to the individual from the stored data or portions of the stored data. These actions are effected and controlled by the use of one or more code modules executing on a “Computer Processor Unit” or CPU, incorporated in the PDH.

One or more code modules executing on a CPU incorporated in the PDH additionally: may cause the CPU to generate a “User Interface” or UI, that is configured to provide information to the individual and accept information or commands from the individual; may cause the CPU to communicate the generated UI to the network connected device used by the individual in communication with the PDH by use of the NCI; may cause the CPU to receive from the network connected device used by the individual in communication with the PDH by use of the NCI, a command to select for provisioning to an entity the generated inference or profile of characteristics that relates to the individual, the communicated generated UI having accepted the command from the individual; may cause the CPU to select for provisioning to the entity the generated inference or profile of characteristics that relates to the individual commanded to be provisioned to the entity by the individual; and may cause the CPU to provision to the entity, by use of the NCI, the selected inference or profile of characteristics that relates to the individual.

Thus, the PDH of the present invention provides a means for an entity to receive an inference or profile of characteristics that has been generated from personal and non-personal data related to an individual, where the inference or profile of characteristics has been communicated to the entity by command of the individual. The communication of an inference or profile of characteristics related to the individual by the direct action of the individual, serves as explicit permission for the entity to employ the individual's inference or profile of characteristics for the advancement of the entity's business interests. With most, if not all, data privacy regimes requiring the prior explicit consent of an individual for an entity to use the individual's personal or non-personal data, either for internal or external purposes, the present invention can significantly ease the burden on an entity associated with meeting the compliance requirements mandated by regulations in the governmental jurisdictions in which they may, or do, operate.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram that depicts the data environment in which a Personal Data Hub of the present invention operates.

FIG. 2 is a flowchart illustrating a sequence of actions performed by a Personal Data Hub of the present invention.

FIG. 3 is a block diagram that depicts components comprising an embodiment of a Personal Data Hub of the present invention.

FIG. 4 is a flowchart illustrating the sequence of actions taken by a Computer Processor Unit incorporated in a Personal Data Hub of the present invention executing a “Data Acquisition Code Module” of the present invention.

FIG. 5 is a flowchart illustrating the sequence of actions taken by a Computer Processor Unit incorporated in a Personal Data Hub of the present invention executing a Data Selection Code Module of the present invention.

FIG. 6 is a flow chart illustrating the sequence of actions taken by a Computer Processor Unit incorporated in a Personal Data Hub of the present invention executing a Personal Data Separation Code Module and a Data Inference Profile Code Module of the present invention.

FIG. 7 is a block diagram that depicts the interactions between the participants in the environment of FIG. 1 and a Computer Processor Unit incorporated in a Personal Data Hub of the present invention, while executing a Querying Entity Interaction Code Module of the present invention.

FIG. 8 is a flowchart illustrating the sequence of actions taken by a Computer Processor Unit incorporated in a Personal Data Hub of the present invention executing a Time Stamp Generation Code Module and a Metadata Marking Code Module of the present invention.

FIG. 9 is a flowchart illustrating the sequence of actions taken by a Computer Processor Unit incorporated in a Personal Data Hub of the present invention executing a “Data Event Detection Code Module” of the present invention.

FIG. 10A is an illustration of a UTF-8 character string that comprises an example Indexing Data Element generated by a Metadata Marking Code Module of the present invention.

FIG. 10B is an illustration of a UTF-8 character string contained in an example text data file that is generated by a Metadata Marking Code Module of the present invention.

FIG. 11 is a flowchart illustrating the sequence of actions taken by a Computer Processor Unit incorporated in a Personal Data Hub of the present invention executing a “Encryption Decryption Code Module” of the present invention.

FIG. 12 illustrates an embodiment of a second system approach of the present invention.

FIG. 13 illustrates an embodiment of a third system approach of the present invention.

### DETAILED DESCRIPTION OF INVENTION

The present invention will now be described more fully hereinafter with reference to the accompanying drawings, which form a part thereof, and which show, by way of illustration, an an embodiment by which the invention may be practiced. The invention may, however, be implemented in the form of many different embodiments and should not be construed as limited to the embodiment set forth herein; rather, this embodiment is provided so that this disclosure will be thorough and complete, and will fully convey the scope of the invention to those skilled in the art. Among other things, the present invention may be embodied as methods or devices. Accordingly, an embodiment of the present invention may take the form of an entirely hardware embodiment, and entirely software embodiment or an embodiment combining software and hardware aspects. The following detailed description is, therefore, not to be taken in a limiting sense.

Throughout the specification, figures, abstract, and claims the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or”, unless the context clearly dictates otherwise. The term “based on” is not exclusive and allows for being based on additional factors not described, unless the context clearly dictates otherwise. In addition, throughout the specification, the meaning of “a”, “an”, “and” and “the” include plural references. The meaning of “in” includes “in” and “on”. Also, the use of “including”, “includes”, “comprising” “comprised of”, “having”, “containing”, “contained in”, “involving”, and variations thereof herein, is meant to encompass the items listed thereafter and equivalents thereof as well as additional items.

Also, throughout the specification, figures, abstract, and claims the following acronyms have the following meanings: ACPU is an acronym for “Apparatus Computer Processor Unit”; ADSU is an acronym for “Apparatus Data Storage Unit”; AI is an acronym for “Artificial Intelligence”; ANCI is an acronym for “Apparatus Network Communication Interface”; API is an acronym for “Application Program Interface”; APP is an acronym for “Application Program”; CCPA is an acronym for the “California Consumer Privacy Act”; CES is an acronym for “Character Encoding Scheme”; CPU is an acronym for “Computer Processor Unit”; DACM is an acronym for “Data Acquisition Code module”; DAPP is an acronym for “Device Application Program”; DCPU is an acronym for “Device Computer Processor Unit”; DDSU is an acronym for “Device Data Storage Unit”; DEDCM is an acronym for “Data Event Detection Code Module”; DID is an acronym for “Device Information Display”; DIPCM is an acronym for “Data Inference Profile Code Module”; DM is an acronym for “Data Mining”; DNCI is an acronym for “Device Network Communication Interface”; DSCM is an acronym for “Data Selection Code Module”; DSP is an acronym for “Data Selection Parameter”; DSU is an acronym for “Data Storage Unit”; EDCM is an acronym for “Encryption Decryption Code Module”; GDPR is an acronym for “General Data Protection Regulation”; GnuPG is an acronym for “Gnu Privacy Guard”; GPS is an acronym for “Global Positioning System”; IOT is an acronym for “Internet Of Things”; IP Address is an acronym for “Internet Protocol Address”; ML is an acronym for “Machine Learning”; MMCM is an acronym for “Metadata Marking Code Module”; NCI is an acronym for “Network Communcation Interface”; NN is an acronym for “Neural Network”; NPD is an acronym for “Non-Personal Data”; OS is an acronym for “Operating System”; PD is an acronym for “Personal Data”; PDC is an acronym for “Personal Data Container”; PDCCM is an acronym for “Personal Data Container Code Module”; PDH is an acronym for “Personal Data Hub”; PDSCM is an acronym for “Personal Data Separation Code Module”; PGP is an acronym for “Pretty Good Privacy”; QE is an acronym for “Querying Entity”; QEICM is an acronym for “Querying Entity Interaction Code Module”; RTC is an acronym for “Real-Time Clock”; TSGCM is an acronym for “Time Stamp Generation Code Module”; two-way DID is an acronym for “two-way Device Information Display”; UI is an acronym for “User Interface”; URL an acronym for “Uniform Resource Locator”; UTC is an acronym for “Coordinated Universal Time”; UUID is an acronym for “Universally Unique Identifier; PDHC is an acronym for “Personal Data Hub Controller” or “PDH Controller”; PDHR is an acronym for “Personal Data Hub Registry”; PDHRDE is an acronym for “Personal Data Hub Registry and Data Exchange” or “PDH Registry and Data Exchange”;

Additionally, throughout the specification, figures, abstract, and claims the term “Computer Processor Unit” or CPU, or variations thereof such as “Apparatus Computer Processor Unit” or ACPU, or “Device Computer Processor Unit” or DCPU, is meant to include a single Computer Processor Unit, or multiple Computer Processor Units. When the term encompasses multiple Computer Processor Units, each of such CPUs may operate on a data element unilaterally, in parallel with another CPU on the same or a different data element, or in serial with another CPU. In this latter case, processed data resulting from actions of a first CPU on a data element are further processed by a second CPU.

In addition, throughout the specification, figures, abstract, and claims a “code module” is defined as a computer program comprised of one or more computer functions that when executed on a Computer Processor Unit (CPU) perform one or more specific actions or tests.

Further, throughout the specification, figures, abstract, and claims a “data element” is defined as a grouping of one or more digital bytes that convey cohesive intelligence. The digital bytes that comprise a data element may represent a single item of intelligence or multiple items of related intelligence. The intelligence carried by the digital bytes of a data element may represent, for example, a physical data value such as a temperature, sound intensity, motion direction, rate, velocity, acceleration, electrical impedance, or capacitance; a set of position coordinates provided by a GPS; a date or time from a RTC; an IP address; a web page address in the form of a URL; a text message, an email, or a notification communicated to, or received from, a network source; a descriptive phrase in the context of a spoken or written language associated with an object, a person, a place, an activity, an attribute, or thing; a reference to, an excerpt from, or a complete written work such as a document, a legal text, a technical publication, a medical record, a financial record, or an authoritative treatise; or a reference to, or a digital representation of, a graphic work such as a drawing, photograph, painting, artistic rendering, or video; or a reference to, or a digital representation of, an audio work such as a musical composition, or sounds present in an audio landscape. Such intelligence may be in human readable form or encoded such that the intelligence may be interpreted by the actions of a CPU operating on the data element. In the discussion that follows, the term “data element” will generally refer to a unit of data input or output from a network connected device used by an individual.

Furthermore, throughout the specification, figures, abstract, and claims “data marking” is defined as the tagging of data with ancillary or supporting data related to the primary payload data; depending on context, the term “information” may be substituted for the term “data”; depending on context, the term “data” may be substituted for the term “information”; the term “public key” may be substituted for the term “public encryption key”; and the term “network address” may be substituted for the term “Internet protocol address”, “IP address”, “Uniform Resource Locator”, “URL”, web address, or any term that refers to a data structure that carries the location of a presence on a network.

Lastly, throughout the specification, figures, abstract, and claims the term “Application Program Interface” or “API” is a set of protocols that define the set form in which data must be presented for interaction with a computer program incorporated in an apparatus or a system, where such apparatus or system may employ a computer program comprised of one code module or an aggregate of code modules.

An apparatus of the present invention acquires and stores data output from a network connected device used by an individual in a network connected storage and data processing apparatus. The apparatus is under the control of the individual. Although the terms “a network connected device” and “the network connected device” are used throughout this discussion in reference to the storage and processing of data acquired from a device used by the individual, an apparatus of the present invention may interact with two or more network connected devices used by the individual simultaneously or in sequence. In this discussion, the apparatus is referred to as a “Personal Data Hub”, or PDH. A “Computer Processor Unit” (CPU), a “Data Storage Unit” (DSU), and a “Network Communications Interface” (NCI) are incorporated in the PDH. A code module executing on the CPU of the PDH causes the CPU to acquire data from the network connected device used by the individual, and to store the acquired data in the DSU of the PDH, the device being in communication with the PDH by use of the NCI of the PDH. In the case of two or more devices used by the individual being in communication with the PDH by use of the NCI of the PDH, the code module executing on the CPU of the PDH will combine the data acquired from each of the devices and store the combined acquired data in the DSU of the PDH, in order to permit the data to be processed as if the data was acquired from a single device. There are many data combining approaches that can used to achieve this result. For example, one such data combining approach is to append data acquired from a second device, used by the individual in control of the PDH, to the data acquired from a first device used by the individual and store the result in a single file in the DSU of the PDH. A second approach is to store data acquired from a second device used by the individual, and data acquired from a first device used by the individual in the DSU of the PDH in two separate files that are linked. In this second approach, the processing of the first file of acquired data would continue past the end of the first file to the processing of the second file to which it is linked. There are many ways to link files to facilitate serial processing of the files. In this discussion, the code module executing on the CPU of the PDH that causes the CPU to acquire data from the network connected device used by the individual who is in control of the PDH, and to store the acquired data in the DSU of the PDH, is referred to as a “Data Acquisition Code module”, or DACM. Processing of the stored data, or a portion of the stored data to generate an inference or profile of characteristics related to the individual, may be effected by a code module executing on the CPU incorporated in the PDH. Under the direction of this code module, the CPU may use stored data acquired from the network connected device used by the individual, in combination with supplementary data related to the individual stored in the DSU of the PDH, to generate the inference or profile of characteristics related to the individual. The acquisition from a network source, and storage of such supplementary data in the DSU of the PDH, may be effected by the CPU using the NCI of the PDH, under the direction of the code module responsible for generating the inference or profile of characteristics related to the individual.

Prior to inference or profile of characteristics generation, a portion of the stored data may be selected for inference or profile of characteristics generation by use of a parameter controlled data selection code module. In this discussion, this code module is referred to as a “Data Selection Code Module” or a DSCM. Example parameters that may be used to control the selectivity of the DSCM include: a time parameter to cause the DSCM to select the portion of the stored data output from the device at a particular time or times; a physical location parameter to cause the DSCM to select the portion of the stored data output from the device that was output from the device when the device was at a particular physical location or physical locations; a URL or IP address parameter to cause the DSCM to select the portion of the stored data output from the device when the device accessed a particular URL or IP address or particular URLs or IP addresses; or an environmental condition parameter to cause the DSCM to select the portion of the stored data output from the device when particular weather conditions were in affect at a location at which the device was situated. A DSCM, or a parameter used by the DSCM, may be incorporated in the PDH at the time of PDH manufacture, downloaded to the PDH from the PDH manufacturer subsequent to the time of the PDH of manufacture, downloaded to the PDH from an entity desirous of obtaining access to a generated inference or profile of characteristics related to the individual, such an entity to be referred to in this discussion as a “Querying Entity”, or QE, or downloaded to the PDH from an independent algorithm developer. Downloading or executing a DSCM, or a parameter used by the DSCM, may be authorized or initiated by the individual by use of a “User Interface” or UI that is communicated to the network connected device used by the individual from the PDH and displayed on a “Device Information Display”, or DID, incorporated in the device, the DID being capable of displaying information visually, acoustically, or tactually to the individual, or accepting information from the individual visually, acoustically, or tactually. In this discussion such a DID is referred to as a “two-way Device Information Display” or “two-way DID”. In the context of the present invention, the two-way DID may include, but not be limited to, an LCD, OLED, MicroLED, quantum dot, or other type of display screen, in cooperation with a separate camera, to display and accept information from the individual “visually”; the two-way DID may include, but not be limited to, a speaker or microphone to display and accept information from the individual “acoustically”; or the two-way DID may include, but not be limited to, a touchscreen display employing vibrational, or non-contact haptic technology, or capacitive, resistive, acoustic wave, optical imaging touch sensitive technologies, or a separate hardware keyboard, keypad, touchpad or other pointing device, to display and accept information from the individual “tactually”. In addition, a DSCM parameter may be provided to the DSCM executing on the CPU of the PDH by the individual visually, acoustically, or tactually by use of the two-way DID. If the PDH does not include a DSCM to select data from the stored data that conforms to a parameter, or the DSCM in the PDH is disabled, all the stored data may be used by the CPU incorporated in the PDH to generate an inference or profile of characteristics related to the individual.

In the present invention the stored data, or a portion of the stored data, output from the device used by the individual, that is processed to generate an inference or profile of characteristics related to the individual, may be separated into a “Personal Data”, or PD, part and a “Non-Personal Data”, or NPD, data part prior to inference or profile processing. Such separation may be effected by use of a “Personal Data Separation Code Module” or PDSCM executing on the CPU incorporated in the PDH. A PDSCM may be incorporated in the PDH at the time of PDH manufacture, downloaded to the PDH from the PDH manufacturer subsequent to the time of manufacture, downloaded to the PDH from a QE, or downloaded to the PDH of from an independent algorithm developer. Downloading or executing a PDSCM may be authorized or initiated by the individual by use of a UI that is communicated to the network connected device used by the individual from the PDH and displayed on a two-way DID incorporated in the device. In addition, the individual may direct that a data element is to be treated as being “personal” by the PDSCM executing on the CPU of the PDH, by use of the two-way DID. In general, the DID may provide information to the individual and accept information or commands from the individual related to the functionality of the PDSCM, visually, acoustically, or tactually.

The processing of the PD or NPD parts of the stored data, or a portion of the stored data, output from the device used by the individual, to generate an inference or profile of characteristics related to the individual, may be effected by a “Data Inference Profile Code Module” or DIPCM executing on the CPU incorporated in the PDH. The DIPCM may employ, for example, Artificial Intelligence (AI), Machine Learning (ML), Neural Network (NN), Data Mining (DM), or other algorithms, to generate from the PD or NPD parts an inference or profile of characteristics. An inference related to the individual may, for example, be a health concern the individual may have, a financial concern the individual may have, a religious belief the individual may hold, a political belief the individual may hold, a propensity of the individual to participate in a particular activity, a current and future desire or need the individual may have, or a predicted future behavior of the individual. A profile of characteristics attributable to the individual may, for example, be comprised of the individual's age, gender, race, religion, family ancestry, financial status, health status, political affiliations, or club affiliations. The DIPCM may be a code module incorporated in the PDH at the time of PDH manufacture, downloaded to the PDH from the PDH manufacturer subsequent to the time of manufacture, downloaded to the PDH from a QE, or downloaded to the PDH from an independent algorithm developer. Downloading or executing a DIPCM may be authorized or initiated by the individual by use of a UI that is communicated to the network connected device used by the individual from the PDH and displayed on a two-way DID incorporated in the device. If the PDH does not include a PDSCM executing on the CPU incorporated in the PDH to separate the stored data into PD and NPD parts, or the PDSCM is disabled, the DIPCM executing on the CPU incorporated in the PDH may employ unseparated stored data, comprised of both PD and NPD data, to generate an inference or profile of characteristics related to the individual.

A code module executing on the CPU incorporated in the PDH, to be referred to in this discussion as a “Querying Entity Interaction Code Module” or QEICM, executing on the CPU incorporated in the PDH, may receive a request from a QE for a generated inference or profile of characteristics related to the individual who is in control of the PDH. The CPU may receive the request from the QE by use of the NCI incorporated in the PDH. The request from the QE would include a network location where the QE wants the PDH to provision the generated inference or profile of characteristics. It may also include a DIPCM that the QE wants the PDH to use to generate the inference or profile of characteristics. Along with the request, the QE may provide information to the QEICM related to the QE. To obtain additional information related to the QE, the QEICM may access supplementary network based data sources by use of the NCI. The DIPCM, if provided, and acquired data related to the QE, may be stored in the DSU incorporated in the PDH.

The QEICM may additionally cause the CPU incorporated in the PDH to communicate information that relates to the requesting QE to the network connected device used by the individual by use of the NCI incorporated in the PDH. The information related to the requesting QE may be processed prior to such communication by the QEICM to provide the individual with a summary of the information related to the QE. This summary may be in a textual, verbal or graphical format to facilitate the ready understanding of the information by the individual. The QEICM may cause the CPU to generate a UI, populate the UI with information related to the requesting QE, and communicate the populated UI to the network connected device used by the individual in communication with the PDH, by use of the NCI. A “Device Application Program”, to be referred to in this discussion as a DAPP, executing on a CPU incorporated in the device used by the individual, to be referred to in this discussion as a “Device Computer Processor Unit”, or DCPU, receives the populated UI, by use of a “Device Network Communication Interface”, to be referred to in this discussion as a DNCI. The DAPP presents the UI to the individual by use of a two-way DID incorporated in the device used by individual. Recall that a two-way DID is capable of displaying information visually, acoustically, or tactually to the individual, or accepting information from the individual visually, acoustically, or tactually. The information related to the requesting QE may include: the QE's identity; the identity of one or more third parties with whom the QE may share the requested inference or profile of characteristics; the categories of third parties with whom the QE may share the requested inference or profile characteristics; the purpose, or purposes, to which the QE may apply the requested inference or profile of characteristics related to the individual; the identity of the QE, manufacturer, or independent algorithm developer that provided the DIPCM to the PDH used to generate the requested inference or profile characteristics; and the conditions defined by the QE that would cause the PDH to provision the requested inference or profile of characteristics to the QE. Such conditions may include the following events: when the device used by the individual visits a particular URL or IP address defined by the QE; when the device used by the individual becomes physically located at a particular physical location defined by the QE, as may be indicated by a GPS incorporated in the device, or some other geolocation positioning system; when a particular time of day, day of week, month of year, or calendar year defined by the QE occurs; when a particular length of time defined by the QE has passed since the previous provisioning to the QE of a requested inference or profile of characteristics; or when an inference or profile characteristics related to the individual has changed from a previous inference or profile of characteristics related to the individual in a way defined by the QE. Such a change may, for example, be in predicted future behavior, current financial status, or current health status.

In addition to information related to the QE, the QEICM may cause the CPU to communicate to the network connected device used by the individual, by use of the NCI incorporated in the PDH, the generated inference or profile of characteristics related to the individual requested by the QE. The requested inference or profile of characteristics may be summarized and formatted into a textual, verbal or graphical presentation prior to such communication by the QEICM to facilitate a ready understanding by the individual of the inference or profile of characteristics and its implications. Note that the QEICM may cause the CPU to generate a UI and populate the UI with the summary or the entire generated inference or profile of characteristics. The QEICM may cause the CPU to communicate the populated UI to the network connected device used by the individual, by use of the NCI incorporated in the PDH. A DAPP executing on a DCPU incorporated in the device used by the individual may present the UI to the individual by use of a two-way DID incorporated in the device used by individual.

The information relating to the QE, or the information relating to the requested inference or profile of characteristics, may be used by the individual to decide whether or not the generated inference or profile of characteristics should be provisioned to the QE. If the individual chooses to have the generated inference or profile of characteristics provisioned to the QE, the individual may use the DID to cause the DAPP executing on the DCPU to communicate a command to the CPU incorporated in the PDH, by use of the DNCI incorporated in the device used by the individual. The command may be to select the requested inference or profile of characteristics for provisioning to the QE immediately or to select the requested inference or profile of characteristics for provisioning to the QE following the detection of an event. The QEICM may receive the command from the network connected device used by the individual by use of the NCI incorporated in the PDH, and carry out the wishes of the individual. In either the immediate or delayed provisioning case, the inference or profile of characteristics is first packaged for provisioning to the QE, such packaging facilitating the QE's use of the inference or profile by the QE. The QEICM then causes the CPU incorporated in the PDH to provision the requested inference or profile of characteristics to the network location provided by the QE, by use of the NCI incorporated in the PDH.

Packaging of Inference or Profile

The packaging of the selected inference or profile of characteristics for provisioning to the QE, may include: the marking of the inference or profile of characteristics with metadata; the generation of a text data file that contains the inference or profile of characteristics marked with metadata; and the encryption of the text data file to the QE's public encryption key. Note that in the context of this discussion “Data Marking” is defined as the tagging of data with ancillary or supporting data related to the primary payload data. With respect to the present invention, the primary payload data is the inference or profile of characteristics related to the individual provisioned to the QE.

Given the above definition of “Data Marking” and “Primary Payload”, the selected inference or profile of characteristics related to the individual may be marked with metadata that carries, some, or all, of the following information, as well as additional information: a time stamp indicating the time the selected inference or profile of characteristics was generated, the QE's identity; the identity of one or more third parties with whom the QE stated it may share the inference or profile of characteristics; the categories of third parties with whom the QE stated it may share an inference or profile characteristics related to the individual; the purpose, or purposes, to which the QE has stated it may apply the inference or profile of characteristics related to the individual; the identity of the QE, manufacturer, or independent algorithm developer that provided the DIPCM used to generate the inference or profile characteristics related to the individual; the event that initiated the provisioning of the inference or profile of characteristics to the QE, and the identity of the PDH.

The marking of the inference or profile of characteristics related to the individual selected for provisioning to the QE with metadata, may be effected by use of a “Metadata Marking Code Module”, or MMCM, executing on the CPU of the PDH. A “Time Stamp Generation Code Module”, or TSGCM, may be executed on the CPU to provide a time stamp to the MMCM. For this discussion, the time stamp may indicate the time the generation of the selected inference or profile of characteristics related to the individual was completed by the DIPCM executing on the CPU incorporated in the PDH. However, the time stamp may indicate other times as well. For example, the time stamp may indicate the time at which the individual selected the inference or profile of characteristics for provisioning to the QE. A real-time clock incorporated in the PDH, synchronized to “Coordinated Universal Time” or UTC, may be used to provide the time to the TSGCM, as well as other code modules, executing on the CPU. The TSGCM may be incorporated in the PDH by the manufacturer of the PDH at the time of PDH manufacture, downloaded to the PDH from the manufacturer of the PDH subsequent to the time of PDH manufacture, or downloaded to the PDH from an independent algorithm developer. Downloading or executing a TSMGM may be authorized or initiated by the individual by use of a UI that is communicated to the network connected device used by the individual from the PDH and displayed on a two-way DID incorporated in the device.

As previously mentioned, the marking of the inference or profile of characteristics selected for provisioning to the QE with metadata may be effected by use of a MMCM executing on the CPU of the PDH. The MMCM executing on the PDH may mark the data comprising the inference or profile of characteristics with metadata by use of a digital data marking technique. The MMCM may be a code module incorporated in the PDH at the time of PDH manufacture, downloaded to the PDH from the PDH manufacturer subsequent to the time of manufacture, or downloaded to the PDH from an independent algorithm developer. Downloading or executing a MMCM may be authorized or initiated by the individual by use of a UI that is communicated to the network connected device used by the individual from the PDH and displayed on a two-way DID incorporated in the device.

The MMCM may also mark the selected inference or profile of characteristics related to the individual with a “PDH Identifier”. The PDH Identifier may be used by the QE to determine when the device used by the individual is in communication with an IP address owned, controlled, used, or accessed by the QE. This may allow the QE to take immediate or subsequent actions that may, for example, be aimed at increasing engagement with the individual visiting the IP address, based on knowledge of the provisioned inference or profile of characteristics related to the individual. Such a determination may be facilitated by a DAPP executing on a DCPU incorporated in the device used by the individual that may be communicated to the device from the PDH. The DAPP may cause the DCPU, by use of a DNCI incorporated in the device, to include the PDH Identifier in the data stream communicated to an IP address visited by the device. By monitoring their web presences, extracting the PDH Identifier marked by the MMCM in the inference or profile of characteristics communicated to the QE, and comparing the extracted marked PDH Identifier with the PDH Identifier communicated to the IP address visited by the device used by the individual, the QE may use the communicated PDH Identifier as notification that the individual in control of the PDH is currently in communication with a particular QE web presence.

It should be noted that although a PDH Identifier may be communicated to an IP address owned, controlled, used, or accessed by the QE, by the device used by the individual, the identity of the individual using the device does not have to be known by the QE. In addition, by use of a UI generated by the DAPP executing on the DCPU, that is displayed on a two-way DID incorporated in the device, the individual using the device may command the PDH to change the PDH Identifier, such that a subsequent inference or profile of characteristics communicated to the QE is marked with a PDH Identifier that is unrelated to the previous PDH Identifier. This has the affect of obsoleting the previous PDH identifier and thereby effectively causing an inference or profile of characteristics provisioned to the QE marked with the previous Identifier to be no longer actionable.

To facilitate the use by the QE of the inference or profile of characteristics related to the individual after it is provisioned to the QE, the inference or profile of characteristics provisioned to the QE may take the form of a simple Unicode character text string marked by metadata inserted into the text string. In this approach, a metadata element may be separated from the inference or profile of characteristics payload by a delimiting character, the delimiting character serving as a label that defines the information carried by the string of characters representing the metadata that follows. A second delimiting character may be used to separate the first metadata element character string from a second metadata element character string, the second delimiting character likewise serving as a label that defines the information carried by the string of characters that follows. The large number of characters defined, for example, by the UTF-8 standard, allows for many different characters that may serve as both metadata labels or separators between metadata elements, to be inserted in the character text string provisioned to the QE, while maintaining compatibility with a large number of Unicode enabled computer programs capable of reading the character text string. With so many different metadata labels available, the inference or profile of characteristics provisioned to the QE may be accompanied by many different categories of metadata elements. By incorporating a Unicode based character look-up table in the inference or profile of characteristics file provisioned to the QE, the QE may readily decode the information carried by a character that may serves as both a label and a delimiting character.

Although in the current discussion a Unicode character text file is used as the data container carrying a marked inference or profile of characteristics related to the individual provisioned to the QE, other data structures may be employed. Such a data structure may be generated by a code module executing on the CPU of the PDH, and is referred to in this discussion as a “Personal Data Container” or PDC. A code module executing on the CPU of the PDH that generates an instance of the PDC, or performs the process of loading an unpopulated PDC with data, is referred to in this discussion as a “Personal Data Container Code Module” or PDCCM. The PDCCM may be a code module incorporated in the PDH at the time of PDH manufacture, downloaded to the PDH from the PDH manufacturer subsequent to the time of manufacture, downloaded to the PDH from a QE, or downloaded to the PDH from an independent algorithm developer. Downloading or executing a PDCCM may be authorized or initiated by the individual by use of a UI that is communicated to the network connected device used by the individual from the PDH and displayed on a two-way DID incorporated in the device.

PDC's may be configured in both standard and proprietary formats. When a PDCCM generates a PDC in a proprietary format, the PDCCM may also generate a reader that can be used to access the marked inference or profile of characteristics loaded into the proprietary PDC. In this case a PDC reader executable may need to be provisioned to the QE along with the inference or profile of characteristics related to the individual. Alternatively, a standardized file format may be employed to serve as a PDC. For example a MySQL SQL database file, a Microsoft Excel spreadsheet file, or a LibreOffice Calc spreadsheet file, may be used as a PDC. In these cases a spreadsheet “row”, or SQL database record, may be loaded with an inference or profile of characteristics, along with the marked metadata related to the inference or profile of characteristics. Since computer programs are readily available that are capable of reading these files, the PDCCM would not need to generate a reader and provision it to the QE to provide the QE with ready access to the marked inference or profile of characteristics loaded into a provisioned standardized PDC.

The packaging of the selected inference or profile of characteristics for provisioning to the QE, may include encrypting the Unicode character data file or PDC loaded with the marked inference or profile of characteristics related to the individual, by the use of public/private key encryption. Alternatively, other forms of cryptography may be used. Encryption of the inference or profile of characteristics may be performed by a code module executing on the CPU of the PDH. The encryption may be performed by an “Encryption Decryption Code Module”, or EDCM, that is incorporated in the PDH by the manufacturer of the PDH at the time of PDH manufacture, downloaded to the PDH from the manufacturer of the PDH subsequent to the time of PDH manufacture, or downloaded to the PDH from an independent algorithm developer. If public/private key encryption is used, the inference or profile of characteristics may be encrypted to the QE's public key, provided to the PDH by the QE, or downloaded from a trusted key server by the PDH, or signed by the PDH's private key, prior to being communicated to the QE. The inference or profile of characteristics may be encrypted or signed so that it can be communicated to the QE as securely as possible. In order to decrypt the signature incorporated in the encrypted inference or profile of characteristics provisioned to the QE, and thus verify that the inference or profile of characteristics was provisioned to the QE from the PDH under the control of the individual, the PDH may also communicate the PDH's public key to the QE. Alternatively, the QE may download the PDH's public key from a trusted key server.

Event Detection

As previously mentioned, the individual may command the PDH to select the generated inference or profile of characteristics related to the individual for provisioning to the QE immediately or to select the generated inference or profile of characteristics for provisioning to the QE following the detection of an event. In the case of provisioning the interference or profile of characteristics when an event occurs, it is necessary for the PDH to effect such provisioning soon after a defined event is detected. An event may be defined by: the individual visually, acoustically, or tactually through the use of a UI communicated to the device from the PDH displayed on a two-way DID incorporated in the device; may be defined by the QE by means of a message communicated from the QE to the PDH by use of the NCI incorporated in the PDH; or may be defined at the time of PDH manufacture by the manufacturer of the PDH. Once the event is defined, a code module executing on the CPU incorporated in the PDH may be used to detect when the event occurs. The event definition may be input to the code module executing on the CPU as a parameter. In this discussion such a code module is referred to as a “Data Event Detection Code Module” or DEDCM. The DEDCM may monitor data output from the device used by the individual communicated to the PDH through the NCI incorporated in the PDH to detect the occurrence of the event. The DEDCM may also monitor data communicated to the PDH through the NCI incorporated in the PDH from other network sources to detect the occurrence of the event. Such network sources may, for example, include, but not be limited to, news, weather, governmental, financial, political, social media, or world clock sources. In addition, the DEDCM may also monitor data output from a hardware module built into the PDH, for example a Real-Time Clock or RTC, incorporated in the PDH at the time of PDH manufacture, to detect the occurrence of the event.

There is a broad range of events that may used to cause an inference or profile of characteristics related to the individual, that has been selected for provisioning to a QE, to be provisioned to the QE. These include: when the device used by the individual visits a particular URL or IP address; when the device used by the individual becomes physically located at a particular physical location, as may be indicated by a GPS incorporated in the device, or some other geolocation positioning system; when a particular time of day, day of week, month of year, or calendar year occurs; when a particular length of time has passed since the previous communication of an inference or profile of characteristics related to the individual has passed; when an inference or profile of characteristics related to the individual has changed from a previous inference or profile of characteristics related to the individual in a defined way, where such a change may, for example, be in predicted future behavior, current financial status, or current health status; when there is a major weather event such as a flood, hurricane, earth quake or tornado in the area in which the individual lives; when there is a major financial change such as a rapidly rising or falling stock market, a significant change in house prices, a large rise or fall in consumer spending, a large rise or fall in employment, or a large rise or fall in the cost of living; or when a major change in governmental policy goes into effect. There are many more events that can be added to this list.

A DEDCM may be incorporated in the PDH at the time of PDH manufacture, downloaded to the PDH from the PDH manufacturer subsequent to the time of the PDH of manufacture, downloaded to the PDH from a QE, or downloaded to the PDH from an independent algorithm developer. Downloading or executing a DEDCM may be authorized or initiated by the individual by use of a UI that is communicated to the network connected device used by the individual from the PDH and displayed on a two-way DID incorporated in the device.

### Preferred Embodiment of Invention

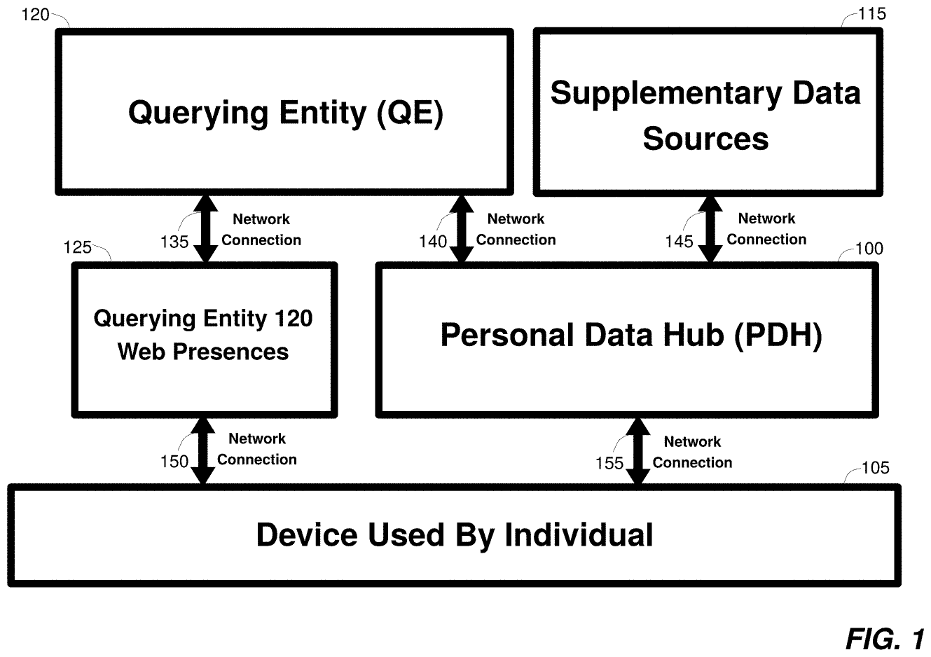

FIG. 1 is a block diagram that depicts the environment in which an apparatus of the present invention operates. As can be seen from FIG. 1, the environment is populated by 5 major participants. These include: Network Connected Device 105 (Device 105) used by an individual; Personal Data Hub 100 (PDH 100), an apparatus of the present invention under the control of the individual using Device 105; Querying Entity 120 (QE 120), an entity requesting to be provisioned a generated inference or profile of characteristics attributable to the individual using Device 105 generated by PDH 100; QE 120 Web Presences 125 owned, controlled, paid for, or otherwise supported by QE 120; and network based Supplementary Data Sources 115 that may provide information to PDH 100 related to the individual using Device 105, QE 120, or the occurrence of events, where such events include, but not limited to, real world, cyber, social, economic, legal, or political events.

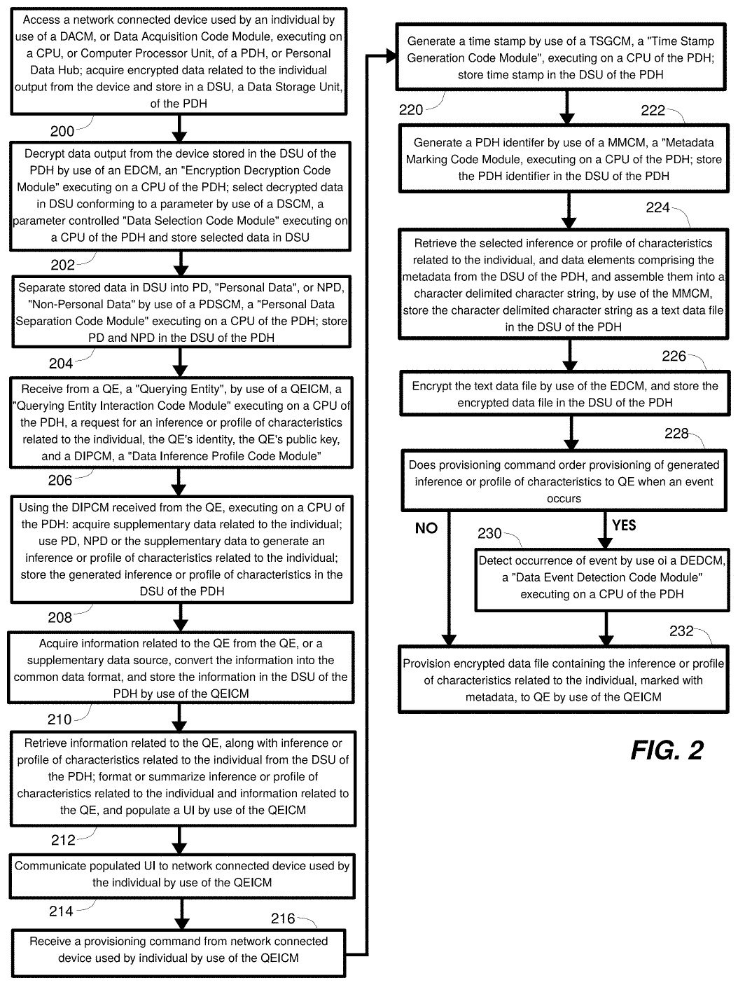

A flowchart of the actions performed by the preferred embodiment of PDH 100, while operating in the environment depicted in FIG. 1, is shown in FIG. 2. Depending on the capabilities offered by the 5 major participants included in the environment of FIG. 1, the actions shown in FIG. 2, as well as the order in which the actions are performed, may differ for other embodiments of PDH 100. However, the major result realized from the actions of other embodiments of PDH 100 of the present invention are to be the same. Specifically, the actions of PDH 100 of the present invention result in the provisioning of an inference or profile of characteristics to QE 120 that has been explicitly commanded to be provisioned to QE 120 by the individual using the device, Device 105, from which the personal or non-personal data used to generate the inference or profile of characteristics, was acquired. FIG. 2 illustrates the series of actions performed to achieve this result by the preferred embodiment of PDH 100.

In Action 200 of FIG. 2, PDH 100 accesses Device 105 used by an individual by use of a code module called a Data Acquisition Code Module (DACM) executing on a Computer Processor Unit (CPU) of PDH 100 using a Network Communications Interface (NCI) incorporated in PDH 100, and acquires personal or non-personal data related to the individual who is using Device 105. This personal or non-personal data is made available to PDH 100 through an Applications Program (APP) installed in Device 105, executing on a Device CPU (DCPU) of Device 105. The APP, to be referred in this discussion as a Device Application Program (DAPP), may be downloaded to Device 105 from PDH 100 or from an APP store operated by the manufacturer of Device 105, and stored in a Device Data Storage Unit (DDSU) of Device 105. Such an APP store may, for example, be the “Google Play” store operated by Google LLC, the “App Store” operated by Apple, Inc, the “Mac Store” operated by Apple, Inc, or the “Microsoft Store” operated by Microsoft, Inc. The DAPP may also be incorporated into Device 105 at the time of its manufacture. For a device serving as Device 105, whose purpose is to acquire specific Device 105 user data, as may be the case for an “Internet Of Things” (IOT) device such as a smart thermostat where the temperature of a room at defined times of the day is acquired, a smart refrigerator or smart washing machine where the need to restock a consumable used by the user of Device 105 is detected, or a fitness tracker where the distance run per day by the user of Device 105 is measured, the DAPP incorporated in the device may not need to provide full functionality. For example, such specific data acquisition devices may not need to include software code to operate a two-way Device Information Display (two-way DID) capable of receiving commands from the user of the specific data acquisition device and communicating such commands to PDH 100.

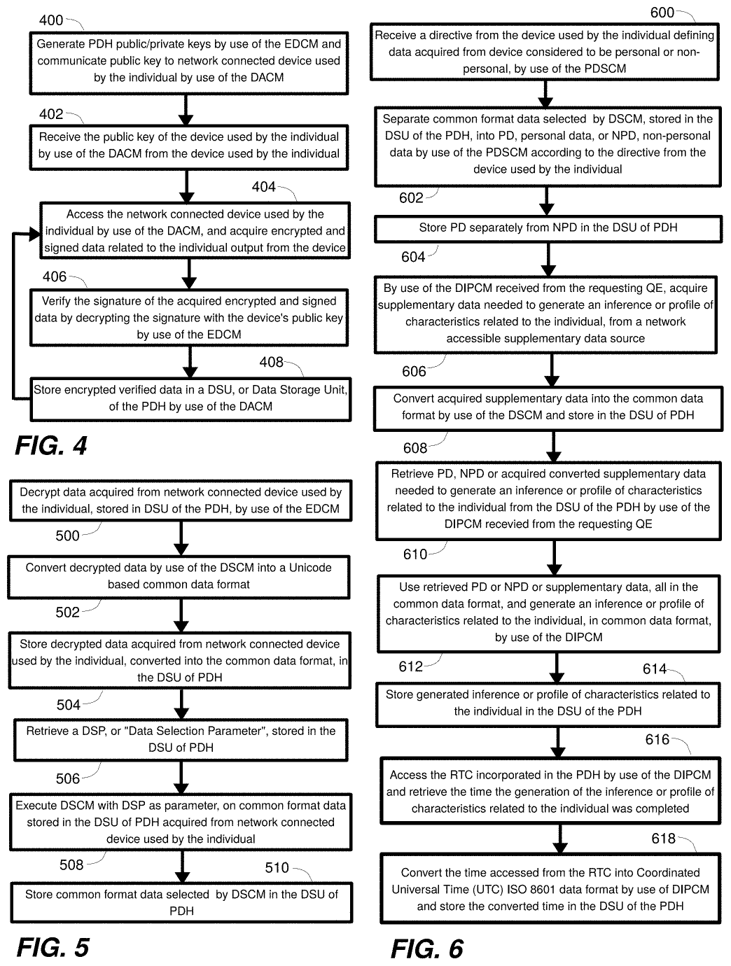

Personal and non-personal data acquired from Device 105 are stored in a Data Storage Unit (DSU) of PDH 100 for later processing by a code module executing on a CPU of PDH 100. Since the PDH DAPP installed in Device 105 used by the individual that collects personal and non-personal data from the use of Device 105 by the individual, is designed to collect as much data related to the individual as possible, including Personally Identifiable Information (PII), such as credit card numbers, or Sensitive Personal Information (SPI), such as health related information, it is necessary, for reasons of security and privacy, for the data to be communicated to PDH 100 in an encrypted form. The preferred embodiment of PDH 100 utilizes public/private key encryption to effect this encryption, although other forms of encryption may be used. To allow the PDH DAPP installed in Device 105 to effect such encryption, the public key of PDH 100 is communicated from PDH 100 to the DAPP incorporated in Device 105 by the DACM executing on a CPU of PDH 100. The DAPP uses the PDH 100's public key to encrypt the user of Device 105's personal or non personal data so that it may only be decrypted by PDH 100, thus allowing Device 105 to communicate the data attributable to the user of Device 105 to PDH 100 over a public network, such as the Internet, with security and privacy. PDH 100 uses its private key to decrypt the personal and non-personal data received from Device 105. For additional security the PDH DAPP installed in Device 105 may communicate the DAPP's public key to PDH 100 and sign the encrypted personal or non personal data attributable to the user of Device 105 to the DAPP's private key. In this case, PDH 100 would use the DAPP's public key to decrypt, and thus verify, the DAPP's signature. This assures that the personal and non-personal data related to the user of Device 105 was actually communicated to PDH 100 from Device 105. Action 200 of FIG. 2 is illustrated in detail in FIG. 4.

In Action 400 of FIG. 4, an Encryption Decryption Code Module (EDCM) incorporated in PDH 100 executing on a CPU of PDH 100 is called by the DACM, generates PDH 100 public and private keys, and stores PDH 100's public and private keys in the DSU of PDH 100. In the preferred embodiment of PDH 100, the EDCM may use “Gnu Privacy Guard” or GnuPG, as well as other public/private key software encryption programs, to effect the generation of PDH 100's public and private keys, the decryption of data received from Device 105 related to the individual using Device 105, and the encryption of the inference or profile of characteristics related to the individual using Device 105 generated by PDH 100 from data received from Device 105, prior to the inference or profile being provisioned to QE 120. The DACM, executing on a CPU of PDH 100, then communicates PDH 100's public key to Device 105 by use of the NCI incorporated in PDH 100. In Action 402, PDH 100 receives Device 105's public key from Device 105, by use of the DACM executing on a CPU of PDH 100, and the DACM stores Device 105's public key in the DSU of PDH 100. The DACM then, in Action 404, accesses Device 105 used by the individual and acquires personal and non-personal data related to the individual that is encrypted to PDH 100's public key and signed to Device 105's private key by the DAPP executing on a DCPU of Device 105. In Action 406 the signature of the encrypted data acquired from Device 105 is verified by the EDCM called by the DACM, by use of Device 105's public key. In Action 408 the encrypted and verified data related to the individual is stored in the DSU of PDH 100 by use of the DACM. Actions 404 through 408 are then continuously repeated in order to acquire and store fresh data related to the individual. The acquisition of personal and non-personal data related to the individual may be initiated: on a timed basis, for example every 5 minutes; when an event occurs, such as when the individual using Device 105 is exercising as reported by a motion sensor incorporated in Device 105; or when Device 105 is located at a particular physical location as reported by a Global Positioning System incorporated in Device 105.

In Action 202 of FIG. 2, personal or non-personal data related to the individual using Device 105, stored in the DSU of PDH 100, are selected by a Data Selection Code Module (DSCM) executing on a CPU of PDH 100, in accordance with a “Data Selection Parameter” (DSP) input to the DSCM. Data selection prior to further processing may significantly increase the speed of subsequent inference or profile of characteristics processing by reducing the quantity of personal or non-personal data needed to effect such processing. A DSP may be provided to PDH 100, for example, by QE 120, or by the manufacturer of PDH 100. Action 202 of FIG. 2 is illustrated in detail in FIG. 5.

As can be seen from Action 500 of FIG. 5, encrypted data acquired from Device 105 used by the individual, stored in the DSU of PDH 100, is decrypted using PDH 100's private key by use of the EDCM called by the DSCM. In Action 502, the resulting unencrypted data is input to the DSCM where it is converted into a common data format. In the preferred embodiment of PDH 100, the unencrypted data is converted to the 8 bits per data unit “Unicode Transformation Format” (UTF-8) Character Encoding Scheme (CES), although another CES may be employed. This conversion may be effected by the DSCM calling a series of open source programs. Commercially available programs, custom programs, or custom algorithms integrated into the DSCM, may be used as well. Since the data acquired from Device 105 may be comprised of a number of different data types, a number of different conversion programs may be required to convert all the acquired data to the UTF-8 common data format. These data types may include, but are not limited to, text data using more than one CES, image data, word processing document data, spreadsheet document data, or HTML encoded web page data. In the case of acquired text data, for example, the conversion to the UTF-8 common data format used by PDH 100 may be best effected by a program that recognizes the CES used by the characters comprising a particular acquired text data element. One program that can accomplish this conversion is “mixconv Version 20160905-1+b1”. The mixconv program can read an acquired data element, analyze the data element to determine whether it utilizes 7-bit ASCII character encoding, 8-bit ASCII character encoding, UTF-8 character encoding, or “Wobbly Transformation Format-8-bit” (WTF-8) character encoding, an extension of UTF-8, convert the characters comprising the data element to UTF-8, and output the result. If the data element is comprised of word processing or spreadsheet document data, the program “catdoc Version 1:0.94.3˜git20160113.dbc9ec6+dfsg-1+deb9u1” may be used. The catdoc program reads a Microsoft Word, Excel, or Powerpoint file and extracts text contained in file. The extracted text is output from catdoc as ASCII text so the DSCM may pipe the output of catdoc to mixconv to convert the catdoc ASCII output to UTF-8. Like wise the html2text Version Vr-1.3.2a-18+b2 program may be called by the DSCM to convert a HTML text page to ASCII text. As in the case of catdoc, the output of html2text may be piped to mixconv to convert html2text ASCII output to UTF-8. In the preferred embodiment of PDH 100, image data may be analyzed to detect objects or recognize faces in the image data and output text describing such objects or faces. It is this text that the DSCM would convert to UTF-8. In this case, the DSCM may call algorithms from the Open Computer Vision library provided by the University at Buffalo, the State University of New York. Their OpenCV Reference Manual Release 2.4.13.7, published on line on Dec. 13, 2018, describes the computer vision algorithms available in the library for execution under the Linux, Mac OS X, and the Windows operating systems, in great detail.

In Action 504, the decrypted data acquired from Device 105 used by the individual, that has been converted into the UTF-8 common data format, is stored in the DSU of PDH 100. Following Action 504, in Action 506, a Data Selection Parameter (DSP) stored in the DSU of PDH 100 is retrieved. As previously discussed, this DSP controls the selectivity of the DSCM. A DSP that causes the DSCM to select the portion of the converted decrypted data acquired from Device 105, when Device 105: was at particular physical location; was at a particular physical location when a particular weather condition was in effect; was accessing a particular set of URL or IP addresses, or was in use at a particular time of day, may significantly reduce the quantity of data acquired from Device 105 required to effect meaningful inference or profile of characteristics processing. A DSP received from QE 120 may be of particular value, for it has the potential of tailoring a generated inference or profile of characteristics to the interests of QE 120. There are many open source data selection programs that can be called by the DSCM to effect the selection of data from a UTF-8 source of data. Commercially available programs, custom programs, or custom algorithms integrated into the DSCM, may be used as well. Tre-agrep 0.8.0-6 is just one open source program that may be use by the preferred embodiment of PDH 100. Using tre-agrep, the DSCM, executing on a CPU of PDH 100, would convert the DSP retrieved from the DSU of PDH 100 into a regular expression and call tre-agrep. The DSP regular expression would be input to tre-agrep and cause tre-agrep to only output data input to tre-agrep that conforms to the selection criteria defined by the DSP regular expression. In the case of the preferred embodiment of PDH 100, the data input to the tre-agrep program would be data acquired from Device 105 converted to the UTF-8 common data format, retrieved from the DSU of PDH 100. The selected Device 105 output data would then be stored in the DSU of PDH 100. These actions are depicted in FIG. 5 Actions 508 and 510.

In Action 204 of FIG. 2, the acquired Device 105 data that has been decrypted, converted to the common data format used by PDH 100, selected, and stored in the DSU of PDH 100 by Action 202, is separated into PD, “Personal Data” (PD), or “Non-Personal Data” (NPD). A “Personal Data Separation Code Module” (PDSCM) executing on a CPU of PDH 100 is used to effect this separation and store the resulting PD and NPD in the DSU of PDH 100 in separate files, allowing each to be individually accessed by subsequent acts of processing. Action 204 of FIG. 2 is illustrated in detail in Actions 600 through 604 of FIG. 6.

As can be seen from Action 600 of FIG. 6, a directive from Device 105 used by the individual may be received by the PDSCM, by use of the NCI of PDH 100, defining data acquired from Device 105 considered to be personal or non-personal by the user of Device 105. The receipt of such a directive is not strictly required for the proper operation of the preferred embodiment of PDH 100. The definition of the data considered to be PD or NPD may be incorporated in PDH 100 at the time of PDH 100 manufacture, and subsequently updated by the manufacturer of PDH 100 as new privacy regulations come into force in various jurisdictions. Alternatively, the data acquired from Device 105 may be used with no separation for subsequent acts of processing. However, providing a means for the individual using Device 105 to express their desires as to what data acquired from their use of Device 105 is considered personal and non-personal, allows the user of Device 105 to have more control over the implications of a generated inference or profile of characteristics that the user of Device 105 may command to be provisioned to QE 120.

In Action 602, selected acquired data from Device 105 in the PDH 100 UTF-8 common data format, stored in the DSU of PDH 100, are separated into PD or NPD by the PDSCM, according to the directive from the user of Device 105, the directive indicating the data elements the user of Device 105 deems personal. Such separation may be effected by a program called by the PDSCM. In the preferred embodiment of PDH 100 one such program that may be used is tre-agrep 0.8.0-6. In this case, to obtain the NPD contained in the data from Device 105, a series of regular expressions are generated by the PDSCM based on the received directive, each regular expression causing tre-agrep to only output the portion of the data input to tre-agrep that does not conform to the regular expression, thus removing data considered personal by the user of Device 105 from tre-agrep's output. This result is effected by calling tre-agrep with the “-v” or “--invert-match” option, which causes tre-agrep to invert the sense of matching and only output non-matching data elements. The PDSCM repeatedly calls tre-agrep with the “--invert-match” option, each call using a regular expression matching a different data element deemed by the user of Device 105 to be personal, while inputting Device 105 data to tre-agrep. This results in tre-agrep outputting data elements considered by the user of Device 105 to be non-personal. Next, to cause tre-agrep to output data elements considered by the user of Device 105 to be personal, the PDSCM repeatedly calls tre-agrep without the “--invert-match” option, each call using a regular expression matching a different data element deemed by the user of Device 105 to be personal, while inputting Device 105 data to tre-agrep. This results in tre-agrep outputting data elements considered by the user of device 105 to be personal. In Action 604, the PDSCM then generates a non-personal data file containing the NPD data elements output from tre-agrep and a personal data file containing the PD elements output from tre-agrep, and stores each file in the DSU of PDH 100. This allows subsequent processing acts to access non-personal data acquired from Device 105 independently from personal data acquired from Device 105 and use the non-personal data and personal data separately, or in combination, to generate an inference or profile of characteristics related to the user of Device 105.

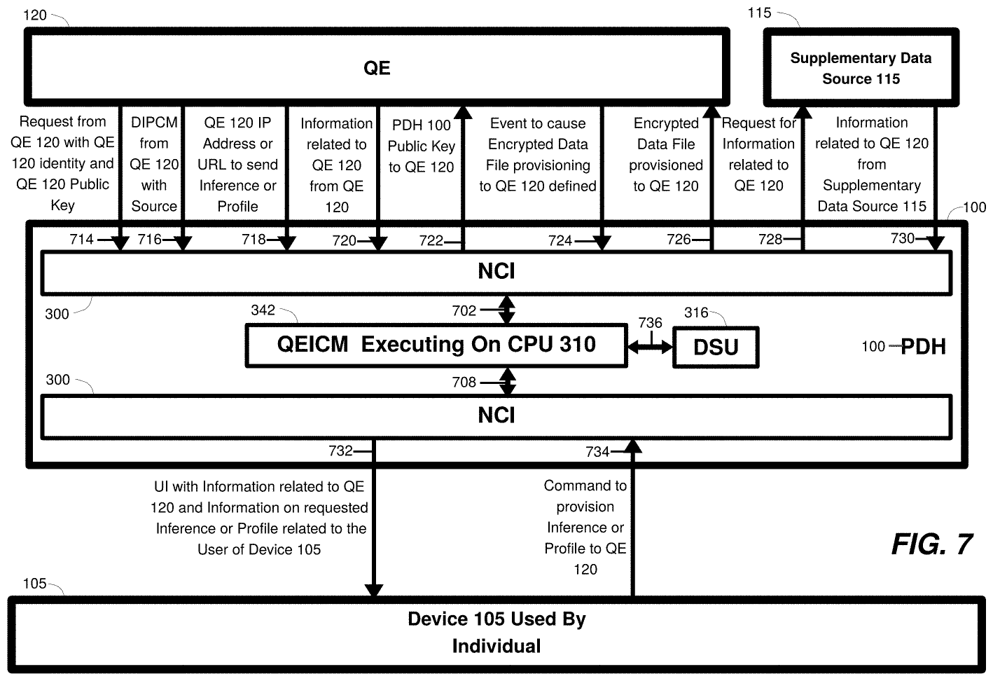

In Action 206 of FIG. 2, a “Querying Entity Interaction Code Module” (QEICM) executing on a CPU of PDH 100, receives a request from QE 120, along with QE 120's identity and QE 120's public key, for an inference or profile of characteristics related to the individual using Device 105, as shown by FIG. 7 Line 714. QE 120's identity and public key is stored in DSU 316 of PDH 100 by use of the QEICM. As shown by FIG. 7 Line 716, QE 120 may additionally communicate to the QEICM the “Data Inference Profile Code Module” (DIPCM) for PDH 100 to use to generate the requested inference or profile of characteristics. Along with the DIPCM, QE 120 may provide to the QEICM the identity of the company, group, or individual who sourced the DIPCM to QE 120. In Action 208 of FIG. 2, using the DIPCM received from QE 120 executing on a CPU of PDH 100, supplementary data related to the individual may be acquired from network accessible supplementary data sources 115 of FIG. 1 by the DIPCM from QE 120, by use of the NCI incorporated in PDH 100. Such supplementary data is then used by the DIPCM in combination with PD or NPD data acquired from Device 105, or by itself, to generate the requested inference or profile of characteristics related to the user of Device 105. The resulting generated inference or profile of characteristics, along with the time the generation of the inference or profile was completed, is stored in the DSU of PDH 100 by the DIPCM from QE 120. Actions 206 and 208 of FIG. 2 are illustrated in detail in Actions 606 through Action 618 of FIG. 6.

In Action 606, supplementary data needed to generate an inference or profile of characteristics related to the individual, is accessed from a network accessible supplementary data source by the DIPCM received from QE 120, executing on a CPU of PDH 100, by use of the NCI incorporated in PDH 100. As is the case for data acquired from Device 105 used by the individual, supplementary data acquired from a disparate group of data sources may be encoded in a wide range of data formats, so in Action 608, the acquired supplementary data is converted into UTF-8 used as the common data format by PDH 100 and stored in the DSU of PDH 100. In the preferred embodiment of PDH 100, the DSCM executing on a CPU of PDH 100 may be used to effect the conversion, by use of the same process employed to convert data acquired from Device 105 to UTF-8. As is the case for data acquired from Device 105, acquired supplementary would be input to the DSCM, and the DSCM would call a series of open source programs, each tailored to convert a different data format to the UTF-8 common data format, to effect the conversion. This process is described in more detail as it relates to Action 502 of FIG. 5.

In Action 610, PD, NPD or acquired converted supplementary data needed to generate an inference or profile of characteristics related to the individual using Device 105 are retrieved from the DSU of the PDH 100 by use of the DIPCM received from QE 120. In Action 612, the retrieved PD, NPD or supplementary data, all in the common data format, are input to the DIPCM received from QE 120 and the DIPCM generates an inference or profile of characteristics related to the individual, in common data format. The generated common data format inference or profile of characteristics is stored in the DSU of PDH 100 by the DIPCM in Action 614.

As previously discussed the DIPCM may use Artificial Intelligence (AI), Machine Learning (ML), Neural Network (NN), Data Mining (DM), or other algorithms, to generate from the PD, NPD or supplementary data an inference or profile of characteristics meaningful to QE 120. Much has been published on such algorithms. For example: “An inference engine for RDF” a masters thesis by Guido Naudts, Open University of the Netherlands, Agfa Gevaert, Oct. 30, 2003, http://www.agfa.com/w3c/2002/02/thesis/thesis.pdf, is a good introduction to the topic of inference engines; “Paradigms of Artificial Intelligence Programming: Case Studies In Common Lisp” by Peter Norvig, Morgan Kaufmann Publishers, San Francisco, Calif., 1992, is a good introduction to artificial intelligence algorithms; and “Data Mining And Analysis: Fundamental Concepts and Algorithms” by Mohammed J. Zaki Rensselaer Polytechnic Institute, Troy, N.Y. and Wagner Meira Jr. Universidade Federal de Minas Gerais, Brazil, Cambridge University Press, 2014 is a good introduction to data mining algorithms. Note that the use of a DIPCM received from QE 120 for the generation of the inference or profile of characteristics related to the user of Device 105 by the preferred embodiment of PDH 100, provides QE 120 with an opportunity to obtain a provisioned inference or profile of characteristics tailored to its needs.

In Action 616 of FIG. 6, a Real-Time Clock (RTC) incorporated in PDH 100 is accessed by use of the DIPCM from QE 120, and the time the generation of the inference or profile of characteristics related to the individual was completed is retrieved. The retrieved time is then converted to a character encoded ASCII text element in the UTC ISO 8601 time format, and stored in the DSU of PDH 100 by use of the DIPCM from QE 120, in Action 618. As will be later discussed, this time will be provided to QE 120 in the form of metadata along with the requested inference or profile of characteristics related to the individual.

With reference to FIG. 7, in Action 210, QEICM 342, executing on a CPU 310 of PDH 100, acquires information related to QE 120 that either has been obtained from QE 120, over Lines 714 and 720, or obtained from network connected Supplementary Data Source 115 by first querying Data Source 115 over line 728, and then receiving information related to QE 120 over Line 730. QEICM 342 then converts the acquired information related to QE 120 to the common data format used by PDH 100, the UTF-8, and stores the information converted to the common data format in DSU 316 of PDH 100 over line 736. As is the case for data acquired from Device 105, acquired data related to QE 120 would be input to the QEICM, and the QEICM would call a series of open source programs, each tailored to convert a different data format to the UTF-8, to effect the conversion. This process is described in more detail as it relates to Action 502 of FIG. 5. In Action 212, the information related to QE 120, along with the inference or profile of characteristics related to the user of Device 105 requested to be provisioned to QE 120, is retrieved from DSU 316 over line 736, and formatted or summarized, by QEICM 342. QEICM 342 then populates a User Interface (UI) generated by QEICM 342 with the information related to QE 120 and the requested inference or profile of characteristics. In Action 214, the UI is communicated to Device 105 by the QEICM 342 over Line 732, and is received by the DAPP executing on the DPCU of Device 105, installed in Device 105 in Action 200. The DAPP renders the received UI and displays the UI visually on a screen, acoustically on a speaker or tactually on a touchpad incorporated in Device 105. The user of Device 105 reviews the information presented by the UI and decides whether to respond to QEICM 342 with a command to provision the requested inference or profile of characteristics to QE 120. If the user of Device 105 reviews the information presented, and decides to have the requested inference or profile of characteristics provisioned to QE 120, the user causes the DAPP to communicate a provisioning command to QEICM 342 over Line 734 by use of an input mechanism incorporated in Device 105. In Action 216, QEICM 342, by the use of NCI 300 incorporated in PDH 100, receives, over Lines 734 and 708, the provisioning command from the user of Device 105.

Before the inference or profile of characteristics commanded to be provisioned to QE 120 by the user of Device 105 is provisioned, the inference or profile of characteristics is first packaged to facilitate QE 120's use of the provisioned data. In the preferred embodiment of PDH 100, such packaging is comprised of the generation of a text data file in the common data format used by PDH 100 that contains the inference or profile of characteristics marked with metadata, and the encryption of the generated text data file to QE 120's public encryption key. In Action 220 of FIG. 2, a first element of metadata is prepared. This first element is a time stamp carrying the time at which the inference or profile of characteristics related to the user of Device 105, commanded to be provisioned to QE 120 by the user of Device 105, was generated by the DIPCM from QE 120 executing on CPU 310 of PDH 100. In Action 220, the time stamp is generated by the use of a “Time Stamp Generation Code Module” (TSGCM) executing on CPU 310 of PDH 100. The TSGCM stores the generated time stamp in DSU 316 of PDH 100. Action 220 of FIG. 2 is illustrated in detail in Actions 800 through 802 of FIG. 8. In Action 800, the TSGCM retrieves from DSU 316 of PDH 100 the time the generation of the selected inference or profile of characteristics related to the individual was completed. The retrieved time is in the form of a character encoded ASCII text element in the UTC ISO 8601 time format. In Action 802, the TSGCM generates a time stamp in PDH 100 UTF-8 common data format from the retrieved UTC ISO 8601 ASCII time data and stores the time stamp in DSU 316. Recall that in Actions 616 through 618 inference/profile generation completion time was obtained from the RTC of PDH 100 and stored in DSU 316 in the UTC ISO 8601 time format by the DIPCM executing on CPU 310. Since the retrieved time is in the form of a character encoded ASCII text element, the TSGCM may call the program “mixconv” to generate a time stamp in PDH 100 UTF-8 common data format from the retrieved UTC ISO 8601 ASCII time data. The discussion of Action 502 of FIG. 5 provides more details as to how mixconv can be used to effect this generation.

In Action 222 of FIG. 2, a PDH Identifier, a second element of metadata, is generated by use of a “Metadata Marking Code Module” (MMCM) executing on CPU 310 of PDH 100. As will be later discussed, a PDH Identifier may be used by QE 120 to determine when Device 105 is in communication with an IP address owned, controlled, used, or accessed by QE 120. Action 222 of FIG. 2 is now discussed in detail with reference to Action 804 of FIG. 8. In Action 804, the MMCM generates the PDH Identifier in the common data format used by PDH 100, UTF-8. The generation of a PDH Identifier may be effected by the use of an open source identifier generator. A commercial identifier generation program, a custom identifier generation program, or a custom identifier generation algorithm integrated into the MMCM may also be used. “uuid 1.6.2” is one such open source program that can be used by the MMCM to generate the PDH Identifier. To generate the PDH Identifier, the MMCM would call uuid 1.6.2 with the command line uuid-v4-F STR|mixconv to generate a random “Universally Unique Identifier” (UUID) as an ASCII text string and pipe the generated ASCII text string to the mixconv program, previously discussed in relation to Action 502 of FIG. 5, to convert the ASCII text string to the UTF-8 common data format used by PDH 100. The resulting PDH Identifier is stored in DSU 316 of PDH 100 by the MMCM.

The MMCM also communicates the PDH Identifier to the DAPP installed in Device 105 by use of NCI 300 incorporated in PDH 100. This allows the DAPP to include the PDH Identifier in the data stream communicated to an IP address visited by the Device 105. By monitoring their web presences, QE 120 can determine when Device 105 is in communication with an IP address owned, controlled, used, or accessed by QE 120. QE 120 can make this determination by comparing the PDH Identifier communicated by Device 105 to the visited IP address with the PDH Identifier incorporated as metadata in the text data file containing the inference or profile of characteristics related to the user of Device 105 provisioned to QE 120 by PDH 100.

In Action 224 of FIG. 2, the selected inference or profile of characteristics to be provisioned to QE 120 by PDH 100, and data elements comprising the metadata that the inference or profile of characteristics is to be marked with, are retrieved from the DSU 316 of PDH 100 by use of the MMCM executing on CPU 310 of PDH 100. They are then assembled into a character delimited character string by use of the MMCM, and the resulting character delimited character string is stored as a text data file in DSU 316 of PDH 316. It is this text data file that is provisioned to QE 120 by PDH 100. Action 224 is illustrated in detail in Actions 806 through 810 of FIG. 8.

In Action 806 of FIG. 8, the selected inference or profile of characteristics to be provisioned to QE 120, the time stamp carrying the time the selected inference or profile of characteristics was generated, information related to QE 120, and the PDH identifier, are retrieved from DSU 316 of PDH 100. All of these data elements are in the form of UTF-8 character strings. The MMCM then adds a label to each data element by appending a unique character included in the UTF-8 character set, but not included in the character string comprising the data element, to the beginning of the data element. The label describes the information carried by the data element. The labeled data elements are then stored in DSU 316 of PDH 100 by the MMCM.

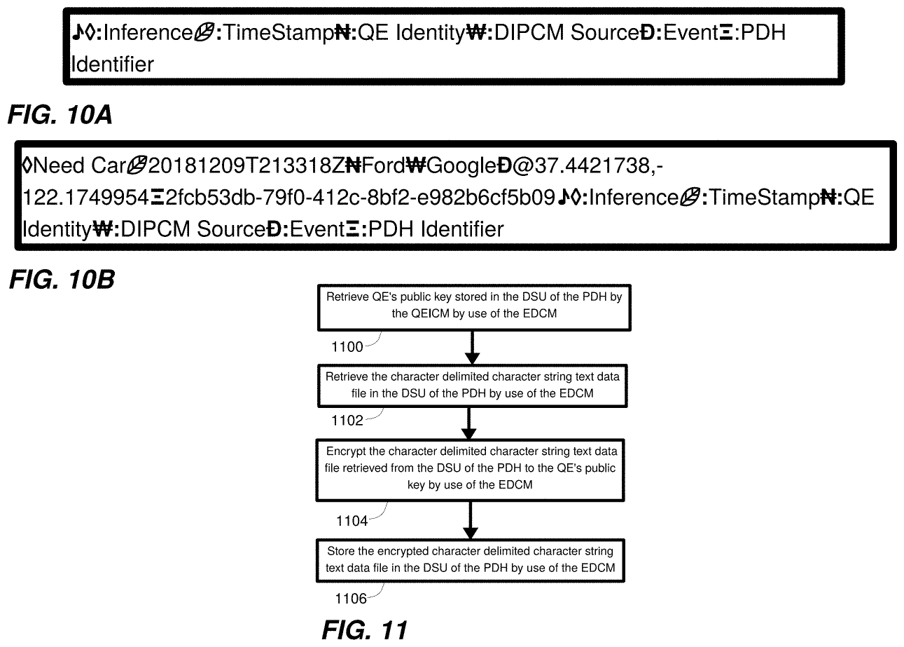

In Action 808, the MMCM generates an Indexing Data Element that provides QE 120 with the data needed to comprehend the meaning of the labels appended to the other data elements. This data element is comprised of a unique first delimiting character, indicating the following character string is an Indexing Data Element, a first label character to be defined, a link UTF-8 character, such as a colon, a UTF-8 character string that defines the meaning of the first label character, a second label character to be defined, the link UTF8 character, a UTF-8 character string that defines the meaning of the second label character, a third label character to be defined, the link UTF-8 character, a UTF-8 character string that defines the meaning of the third label character, and so forth. The generated Indexing Data Element is then stored in DSU 316 of PDH 100 by the MMCM. FIG. 10A depicts a UTF-8 character string that comprises an example Indexing Data Element generated by the MMCM of the preferred embodiment of PDH 100.

In Action 810, the MMCM assembles the labeled selected inference or profile of characteristics related to the individual, the labeled time stamp, the labeled information related to the QE, the labeled PDH identifier, and the Indexing Data Element, retrieved from DSU 316 of PDH 100, into a UTF-8 character delimited character string, and stores the assembled character string as a text data file in DSU 316 of PDH 100. FIG. 10B is an illustration of an example UTF-8 character string assembled by the MMCM. It can be seen from FIG. 10B that characters 1, 10, 27, 32, 39, 64, 101, 102, 103, 113, 114, 124, 133, 134, 146, 148, 154, and 155 in the character string may serve as labels, delimiters, or links. Being in the first position of the character string, character 1 of FIG. 10B, “⋄”, is a label. This label indicates that the following UTF-8 characters provide information pertaining to an inference generated from personal or non personal data acquired from Device 105, by use of the DIPCM provided to the PDH 100 from QE 120. The inference, “need car”, indicates that the user of Device 105 may have a need to purchase, or acquire the use of a car. We know that the “⋄” character precedes the description of an inference in the character string because the index data element, which follows the index data element label character “ [symbol] ” in character position 101 of the character string, linked the “⋄” character to the term “inference” by use of the link character “:”. Character 10 in the character string, “ [symbol] ”, serves as both a delimiter and a label. It separates the following character string from the inference description that precedes it, while labeling the following character string as a time stamp data element. The time stamp shown indicates that the preceding inference was generated on Dec. 9, 2018 at 21:33:18 Coordinated Universal Time (UTC). We know that the “ [symbol] ” character precedes a time stamp in the character string because the index data element linked the “ [symbol] ” character to the term “TimeStamp” by use of the link character“:”. Character 27 in the character string, “ [symbol] ”, serves as both a delimiter and a label. It separates the following character string from the time stamp description that precedes it, while labeling the following character string as a QE Identity data element. The QE Identity data element shown indicates that the preceding inference was requested by the “Ford Motor Company”. We know that the “ [symbol] ” character precedes a QE Identity data element character string because the index data element linked the “ [symbol] ” character to the term “QE Identity” by use of the link character“:”. Character 32 in the character string, “ [symbol] ”, serves as both a delimiter and a label. It separates the following character string from the QE Identity description that precedes it, while labeling the following character string as a DIPCM Source data element. The DIPCM Source data element shown indicates that the preceding inference was generated by a DIPCM sourced by “Google LLC”. We know that the “ [symbol] ” character precedes a DIPCM Source character string because the index data element linked the “ [symbol] ” character to the term “DIPCM Source” by use of the link character“:”. Character 39 in the character string, “ [symbol] ”, serves as both a delimiter and a label. It separates the following character string from the DIPCM Source description that precedes it, while labeling the following character string as an Event data element. The Event data element shown indicates that the provisioning of the preceding inference to the identified QE, in this case the Ford Motor Company, was initiated by the event of Device 105 being located at the the GPS coordinates “37.4421738,-122.1749954”. This is the GPS coordinates of the Tesla Inc. dealership at the Stanford Shopping Center in Palo Alto, Calif. We know that the “ [symbol] ” character precedes an Event character string because the index data element linked the “ [symbol] ” character to the term “Event” by use of the link character“:”. Character 64 in the character string, “ [symbol] ”, serves as both a delimiter and a label. It separates the following character string from the Event description that precedes it, while labeling the following character string as a Personal Data Hub (PDH) Identifier data element. The PDH Identifier data element shown indicates that the preceding inference provisioned to the identified QE, the Ford Motor Company, was provisioned by a particular Personal Data Hub (PDH), in this case the PDH identified by the UUID 2fcb53db-79f0-412c-8bf2-e982b6cf5b09. We know that the “ [symbol] ” character precedes a PDH Identifier character string because the index data element linked the “ [symbol] ” character to the term “PDH Identifier” by use of the link character“:”. Character 101 in the character string, “ [symbol] ”, serves as a delimiter and a label. It separates the following character string from the PDH Identifier character string that precedes it, while labeling the following character string as an Indexing Data Element. In the preferred embodiment of PDH 100, the “ [symbol] ” character is predefined to indicate that the characters following its occurrence are those of an Indexing Data Element, although other delimiting characters may be used. At the completion of Action 810, the MMCM stores the assembled character string as a text data file in DSU 316 of PDH 100.

In Action 226 of FIG. 2, the text data file assembled in Action 224 to be provisioned to QE 120, is retrieved form DSU 316 of PDH 100, and encrypted to QE 120's public key by use of a “Encryption Decryption Code Module” (EDCM). The encrypted file is stored in DSU 316 of the PDH 100 for later provisioning to QE 120. Action 226 is illustrated in detail in Actions 1100 through 1106 of FIG. 11. In Action 1100, QE 120's public key, stored in the DSU of the PDH by the QEICM in Action 206, is retrieved by use of the EDCM. The text data file to be provisioned to QE 120 is then retrieved from DSU 316 of PDH 100 by use of the EDCM, in Action 1102. In Action 1104 through 1106, the text data file to be provisioned to QE 120 is encrypted to QE 120's public key, and stored in DSU 316 of PDH 100, by use of the EDCM.

At Action 228 of FIG. 2, the data comprising the text data file commanded to be provisioned to QE 120 by the user of Device 105, has been acquired, converted to the UTF-8 common data format used by PDH 100, processed as taught by the present invention, and encrypted to QE 120's public key. At this point in the present invention's process flow, the text data may be provisioned to QE 120. However, if the provisioning command from the user of Device 105 includes an order to provision the generated inference or profile of characteristics relating to the user of Device 105 to QE 120 at the occurrence of an event, such an event needs to be detected prior the text data file being provisioned. In Action 228, whether or not the provisioning command includes the directive to provision the text data file when an event occurs, is determined. If it does, process flow continues to Action 230 of FIG. 2. If it does not, process flow continues to Action 232 of FIG. 2.

In Action 232 of FIG. 2, since no event has been directed to be detected, The encrypted text data file, containing the inference or profile of characteristics related to the user of Device 105, marked with metadata, is provisioned, over Line 726 of FIG. 7, by use of the QEICM, to the IP Address or URL provided to the QEICM by QE 120 over Line 718 of FIG. 7.

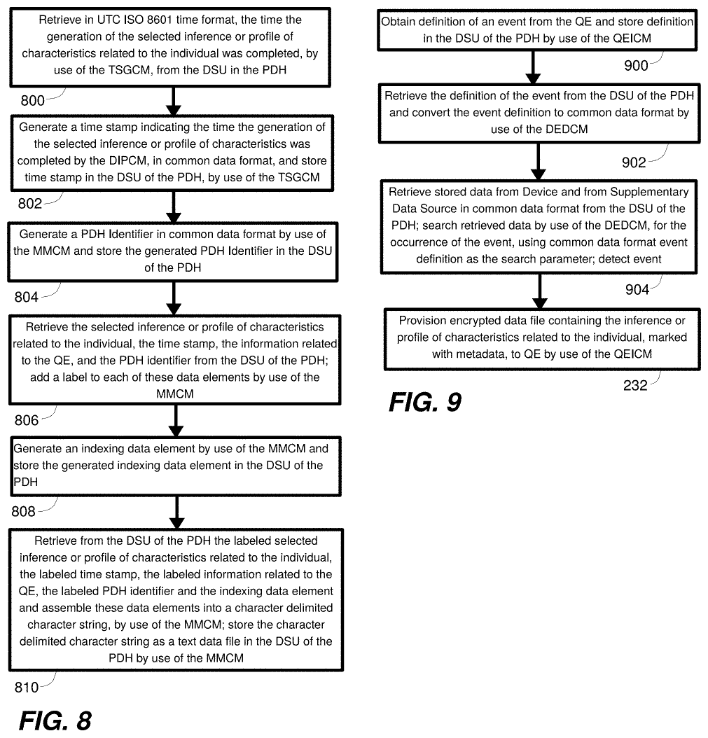

In Action 230 of FIG. 2, the occurrence of the event defined by QE 120, and communicated to the QEICM of PDH 100 over line 724 of FIG. 7, is detected by a “Data Event Detection Code Module” (DEDCM) executing on CPU 310 of PDH 100. Process flow continues to Action 232 where the encrypted text data file containing the inference or profile of characteristics related to the user of Device 105, marked with metadata, is provisioned to QE 120 by use of the QEICM. Action 230 is illustrated in detail in Actions 900 through 904 of FIG. 9.

In Action 900 of FIG. 9, the QEICM obtains the definition of an event from QE 120 and stores the event definition in DSU 316 of PDH 100. In Action 902, the event definition is retrieved from DSU 316 of PDH 100 and converted to the UTF-8 common data format used by PDH 100 by use of the DEDCM. As previously discussed in relation to Action 502, the open source program “mixconv” can be used for this purpose. Stored data from Device 105 and Supplementary Data Source 115, previously converted to the UTF-8 common data format of PDH 100, is then retrieved from DSU 316 of PDH 100 and searched in Action 904 by a data selection program called by the DEDCM, for the occurrence of the event, using the UTF-8 converted event definition as the search parameter. When a match occurs, the matched data string is output from the data selection program indicating to the DEDCM that the event has occurred. PDH 100 may call an open source data selection program, such as “tre-agrep”, as discussed in relation to Action 504, as the data selection program, although commercially avaialble data selection programs, custom data selection programs, or a custom data selection algorithm integrated into the DEDCM may also be used for this purpose. In the case of a defined “compound event”, that is the occurrence of two or more separate events needing to take place for the DEDCM to determine that the event has occurred, the data selection program may be called multiple times, with different search parameters, by the DEDCM. When the DEDCM determines that the event has occurred, process flow proceeds to Action 232, where the encrypted text data file containing the inference or profile of characteristics related to the user of Device 105, marked with metadata, is provisioned to QE 120 by use of the QEICM.

The UTF-8 character string shown in FIG. 10B, includes an event data element, [symbol] @37.4421738,-122.1749954, that can serve as an example of an event definition that may be detected by the DEDCM. In the context of Actions 230 and 232 of FIG. 2, the occurrence of this event data element in data acquired from Device 105, directs the encrypted text data file containing the marked inference or profile of characteristics related to the user of Device 105, commanded to be provisioned to QE 120 by the user of Device 105, to be provisioned to QE 120 when Device 105 is located at the GPS coordinates “37.4421738,-122.1749954”. These are the GPS coordinates of the Tesla Inc. dealership at the Stanford Shopping Center in Palo Alto, Calif. Using tre-agrep as the data selection program called by the DEDCM, with GPS coordinates “37.4421738,-122.1749954” as the search string parameter, causes tre-agrep to output a match when the user of Device 105 is located at the Stanford Shopping Center Tesla dealer. This match results in the QEICM provisioning to QE 120, the encrypted marked text data file containing the inference or profile of characteristics related to the user of Device 105. The data related to Device 105's user may be then employed by QE 120 to advance its business interests while Device 105's user is located at the Tesla dealer.

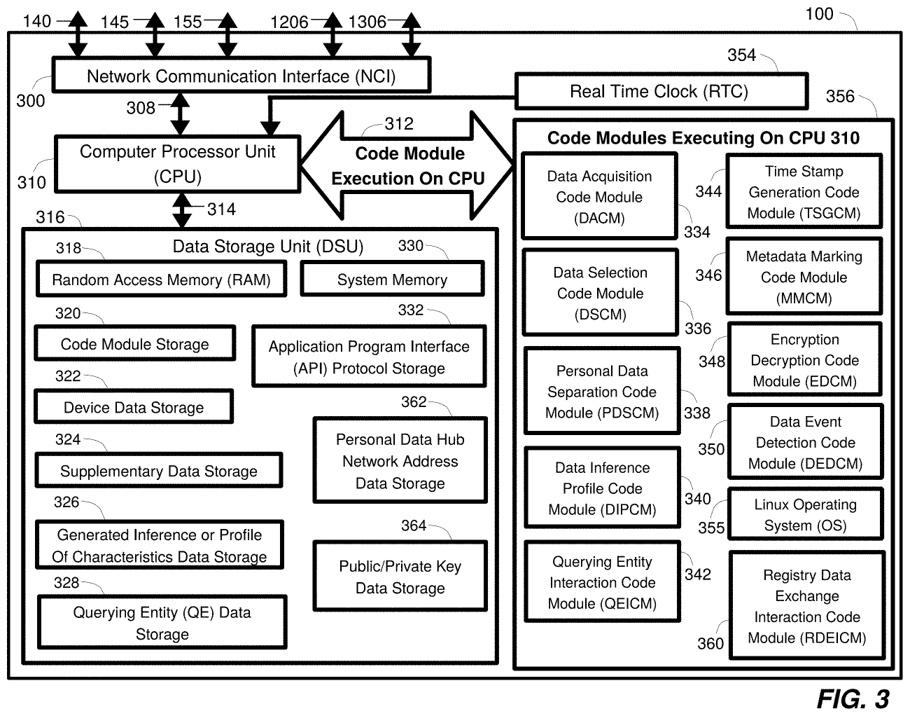

The configuration of PDH 100 will now be discussed. FIG. 3 is a block diagram that depicts components comprising an embodiment of PDH 100 of the present invention. Referring to FIGS. 1 and 3, PDH 100 interacts with the participants in the data environment depicted in FIG. 1 over 3 lines, Lines 140, 145 and 155. Data communicated to PDH 100 from Device 105 over Line 155 includes, but is not limited to: data acquired by Device 105 related to the user of Device 105, where such user is the controller of PDH 100; Device 105's Public Key; and commands or directives from the user of Device 105. Such commands or directives include: a command to provision an inference or profile of characteristics related to the user of Device 105 to QE 120; a directive that causes PDH 100 to provision such an inference or profile of characteristics to QE 120 when an event occurs; a command to change the PDH 100's Identifier to one unrelated to PDH 100's current Identifier; and a directive defining data acquired from Device 105 considered to be personal or non-personal by the user of Device 105. Data communicated from PDH 100 to Device 105 over Line 155 includes, but is not limited to: PDH 100's Public Key; QE 120's identity; data related to QE 120; the identity of the provider who sourced DIPCM 340 used to generate the inference or profile of characteristics related to the user of Device 105; and a summary of the inference or profile of characteristics related to the user of Device 105 generated by DIPCM 340 executing on CPU 310 of PDH 100.

Data communicated to PDH 100 from QE 120 over Line 140 includes, but is not limited to: a request from QE 120 for an inference or profile of characteristics that relates to the user of Device 105; QE 120's identity; QE 120's Public Key; the DIPCM that QE 120 wants PDH 100 to use for DIPCM 340 for the generation of the requested inference of profile of characteristics; the identity of the company, group, or individual that sourced the DIPCM QE 120 wants PDH 100 to use; the IP Address or URL to which QE 120 wants PDH 100 to provision the Inference or Profile Characteristics related to the user of Device 105; information related to QE 120; QE 120's Public Key; and the definition of the event that is to cause PDH 100 to provision to QE 120 the text data file requested by QE 120, the text data file being comprised of the inference or profile of characteristics related to the user of Device 105 marked with metadata, and encrypted to QE 120's public key. Data communicated from PDH 100 to QE 120 over Line 140 includes, but is not limited to, the encrypted text data file requested by QE 120. Note that Lines 714, 716, 718, 720, 722, 724, and 726 of FIG. 7, in aggregate, comprise Line 140 of FIG. 3.

Data communicated to PDH 100 from Supplementary Data Source 115 over Line 145 includes, but is not limited to: information related to QE 120 requested by PDH 100; and information related to the user of Device 105 requested by PDH 100. Data communicated from PDH 100 to Supplementary Data Source 115 over Line 145 includes, but is not limited to: a request for information related to QE 120; and a request for information related to the user of Device 105.

Process Arrow 312 of FIG. 3 indicates that Code Modules 356 are executed on CPU 310 of PDH 100. These code modules may be executed in parallel or serially depending on the configuration of CPU 310, and the availability of data acquired by, or communicated to, PDH 100 by use of NCI 300. In the preferred embodiment of PDH 100: Data Acquisition Code Module (DACM) 334 acquires data from Device 105 used by the individual in control of PDH 100; Data Selection Code Module (DSCM) 336 selects data from the data acquired from Device 105 in accordance with a Data Selection Parameter (DSP) provided by QE 120; Personal Data Separation Code Module (PDSCM) 338 separates the selected acquired data in Personal Data (PD) and Non-Personal Data (NPD) parts; Data Inference Profile Code Module 340 processes the PD or NPD parts of the selected acquired data and generates an inference or profile of characteristics related to the user of Device 105; Querying Entity Interaction Code Module (QEICM) 342 interfaces with QE 120 and obtains data and software code related to the processing of data acquired from Device 105, and the provisioning of the results of such processing; Time Stamp Generation Code Module (TSGCM) 344, using time data output from Real-Time Clock (RTC) 354, generates a time stamp used to mark data contained in the text data file commanded to be provisioned to QE 120 by the user of Device 105 with the time at which the inference or profile of characteristics included in the text data file was generated by DIPCM 340; Metadata Marking Code Module (MMCM) 346 marks data contained in the text data file commanded to be provisioned to QE 120 by the user of Device 105 with metadata; Encryption Decryption Code Module (EDCM) 348 encrypts the text data file commanded to be provisioned to QE 120 by the user of Device 105 to the Public Key of QE 120; Data Event Detection Code Module (DEDCM) 350 detects the occurrence of an event defined by QE 120 and causes the encrypted text data file commanded to be provisioned to QE 120 by the user of Device 105 to be provisioned to QE 120; Linux Operating System (OS) 355 serves as the executive program under which Code Modules 356 operate.

Data Storage Unit (DSU) 316 of the preferred embodiment of PDH 100, serves as the central repository for data stored and processed by PDH 100. Acquired data and Public Keys from Device 105 are stored in Device Data Storage 322; data and Public Keys provided to PDH 100 from QE 120 are stored in Querying Entity (QE) Data Storage 328; supplementary data related to QE 120 and the user of Device 105 are stored in Supplementary Data Storage 324; generated inference or profile of characteristics related to the user of Device 105 are stored in Generated Inference or Profile Of Characteristics Data Storage 326; Linux Operating System software code, and the software code for the programs that run under Linux, are stored in Systems Memory 330; transient processing and operating system data are stored in Random Access Memory (RAM) 318; and Code Modules 356 executable code are stored in Code Module Storage 320. The aggregate amount of data that may be stored over time by DSU 316 is quite large, thus the preferred embodiment of PDH 100 may use one or more large format 25 or more Terabyte hard disk drives for non-volatile storage, and 32 Gigabytes or more of RAM for transient storage. DSU 316 may use Solid State Drives (SSD) in place of, or in addition to, hard disk drives for non-volatile storage.

Although the preferred embodiment of PDH 100 employs the memory partitioning shown, other memory partitioning configurations may be used. The choice of the memory partitioning configuration is effected by the number and type of processing engines that comprise CPU 310. In the simplest case, a single general purpose microprocessor, such as a Ryzen 7 2700X 8 core processor manufactured by Advanced Micro Devices (AMD) may, for example, be chosen for use as CPU 310. Although this device operates using a clock frequency of 3700 MHz, its basic architecture conforms to the microprocessor x64 architecture used for general computing. Therefore, one or more special purpose processing engines may be incorporated in CPU 310, along with a general purpose microprocessor, to address the need to process large quantities of data acquired from Device 105 and generate inferences and profiles of characteristics related to the user of Device 105 in an acceptable period of time. In this case, the general purpose microprocessor may be tasked with hosting Linux Operating System 355, and coordinating the processing activities of the one or more additional special purpose processing engines. Special purpose processing engines that may be used by PDH 100 are, for example, the Graphcore Colossus GC2 Processor, or the NVIDIA Tesla V100 GPU Accelerator.

Turning now to the system aspects of the present invention, it can be seen from FIG. 7 that PDH 100, Device 105, and QE 120 comprise a first system approach of the present invention for provisioning to an entity, in this case Querying Entity 120, processed data related to an individual. Before QEICM 342 executing on CPU 310 of PDH 100 may receive a request from QE 120 on Line 714 for processed data, comprised of an inference or profile of characteristics related to the individual using Device 105, along with a statement of QE 120's identity, and QE 120's public encryption key, also to be referred to as QE 120's public key, QE 120 needs to first, be made aware of the existence and network presence of a PDH 100; second, be provided with data related to the characteristics of the processed data available from PDH 100; and third, be network connected to PDH 100. Data related to the characteristics of the processed data, for example, may be a description of categories into which characteristics of the processed data available from PDH 100 may be placed. Such data is needed in order for QE 120 to be able to determine if QE 120 has an interest in receiving processed data from PDH 100. A network connection between QE 120 and PDH 100 needs to be established so that two-way communication between QE 120 and PDH 100 may occur. In a first system approach to effect these actions, PDH 100 may publish on a network, the Internet for example, by use of a website indexed by an Internet search engine, information related to PDH 100's offering of processed data. QE 120 could then locate the website using a standard Internet search engine, such as Google, DuckDuckGo, or Bing, access the website, and obtain the information. The information may include a description of categories in which characteristics of the processed data available from PDH 100 may be placed, along with a network address that may be used by interested entities, such as QE 120, to connect to PDH 100. If QE 120, or any other QE, has an interest in the processed data provisioned by PDH 100, the QE may establish direct communication with PDH 100 using the provided network address. If PDH 100's Controller, or PDHC, determines that the provisioning of PDH 100 processed data to QE 120 is of interest, QE 120 may be provisioned by use of NCI 300, processed data that relates to PDH 100's PDHC from PDH 100, as directed by QEICM 342 executing on CPU 310. The data that relates to PDH 100's PDHC received from Device 105 stored in Data Storage Unit (DSU) 316 is withheld from QE 120 by QEICM 342.

In a second system approach to effect these actions, PDH 100 makes its presence on a network known by registering with a network service registry. In the discussion that follows, this network service registry is referred to as a Personal Data Hub Registry or PDHR. Such registration can be effected by PDH 100, using publicly known PDHR IP addresses or URLs, along with published PDHR Application Program Interface protocols, at the time PDH 100 connects to a network, the Internet for example. PDHR IP addresses or URLs, and PDHR Application Program Interface protocols of a number of PDHRs may also be incorporated in PDH 100 at the time of PDH 100 manufacture by the manufacturer of PDH 100. PDH 100 may also be periodically updated with new PDHR IP addresses or URLs, and PDHR Application Program Interface protocols by the manufacture of PDH 100 or a third party service.

The process of registration comprises communicating data elements that carry five groups of data from a PDH to a PDHR. The first group are data elements that serve as a header. This header indicates that following data elements emanate from a PDH. The second group are data elements that carry data related to the characteristics of the processed data available from the registering PDH. The third group are data elements that carry the public encryption key of the PDH. The fourth group are data elements that carry the Application Program Interface protocols that can be used to interact with the PDH. The fifth group are data elements that carry an IP address that can be used to establish network communication with the PDH. Although the IP address can provide direct two-way communication between the PDH and a PDHR, in many cases the controller of the registering PDH, the PDH Controller, or PDHC, may choose to direct outgoing communication to the PDHR, and incoming communication from the PDHR, through a proxy server in order to obtain a measure of privacy and security. Recall that in the present invention the individual using Device 105, whose processed data in the form of inferences or profiles of characteristics is being offered for provisioning to QE 120 by PDH 100, is the individual who controls PDH 100, the PDHC.

Except for the first group of data elements, the header data elements, the data elements that comprise the second, third, fourth and fifth groups of data elements communicated from PDH 100 to a PDHR may be encrypted to the public key of the PDHR. PDH 100 may obtain the public key of the PDHR from a public key server, or, using publicly available PDHR IP Addresses or URLs obtained from a supplementary information source, directly from the PDHR. PDH 100 may also be provided with the public keys and IP addresses of a number of PDHRs at the time of manufacture by the manufacturer of PDH 100. PDH 100 may also be periodically updated with new or updated public keys and PDHR IP addresses by either accessing a PDHR public key and IP address repository maintained by the manufacturer of PDH 100, or a repository maintained by a third party. The PDHR decrypts the encrypted data elements received from PDH 100 using its private key, and may incorporate some or all of the unencrypted data from the five groups of data elements communicated to the PDHR from PDH 100 into a database record. Such a database record may equate the data elements in the second group of data elements communicated to the PDHR from PDH 100 that carry data related to the characteristics of the processed data available from PDH 100, with the data elements in the third group of data elements communicated to the PDHR from PDH 100 that carry the public encryption key of PDH 100, with the data elements in the fourth group of data elements communicated to the PDHR from PDH 100 that carry the Application Program Interface protocols that can be used to interact with PDH 100, with the data elements in the fifth group of data elements communicated to the PDHR from PDH 100 that carry the IP address that can be used to establish network communication with PDH 100.

In the second system approach of the present invention, QE 120 establishes communication with a PDHR hosting a database comprised of database records associated with a plurality of PDHs, including PDH 100, using a published PDHR network address, and published PDHR Application Program Interface protocols, and reviews the database record associated with PDH 100, as well as the database records associated with other PDHs. If QE 120 determines that PDH 100 offers processed data of interest, QE 120 obtains the Application Program Interface protocols that can be used to interact with PDH 100, the IP address of PDH 100 and the public key of PDH 100. Using the Application Program Interface protocols and IP address obtained from the PDHR, QE 120 initiates communication with PDH 100. Such review may be facilitated by the PDHR providing a search engine, for example, a “Structured Query Language” or SQL search engine, though other search engines may be employed, that allows QE 120 to search the fields of PDH database records and obtain a listing of PDHs that offer processed data of potential interest to QE 120.

For purposes of privacy and security, encrypted communication between PDH 100 and QE 120 may be desirable. Since QE 120 already has access to PDH 100's public encryption key through the PDHR from which it obtained PDH 100's IP address, PDH 100 may be configured such that it only accepts data encrypted to its public key, for example encrypted data from QE 120. After initial one-way encrypted communication between PDH 100 and QE 120 is initiated by QE 120, by use of PDH 100's IP address obtained from the PDHR, QE 120 may effect two-way encrypted communication with PDH 100 by providing PDH 100 with its public encryption key. Such two-way encrypted communication may be important during and after the interaction between QE 120 and PDH 100 which takes place for the purpose of establishing a working relationship. The use of encrypted communication between QE 120 and PDH 100 may be desirable whether or not communication between the QE 120 and the PDH 100 has been established through a proxy server, or by use of a direct PDH 100 IP Address. The continued use of encrypted communication between a PDH 100 and QE 120 may be especially important after QE 120 has been authenticated as being a legitimate entity by the PDHC of PDH 100, the PDHC has established a working relationship with QE 120, and the PDHC has agreed to direct PDH 100 to provision PDH 100 processed data to QE 120.

After QE 120 has established communication with PDH 100, communication between QE 120 and PDH 100 does not pass through the PDHR. This distances the operators of the PDHR from personal, non-personal, or processed data communicated between PDH 100 and QE 120, and makes the PDHR less subject to privacy regulations in force in the jurisdictions in which PDH 100 and QE 120 operate.

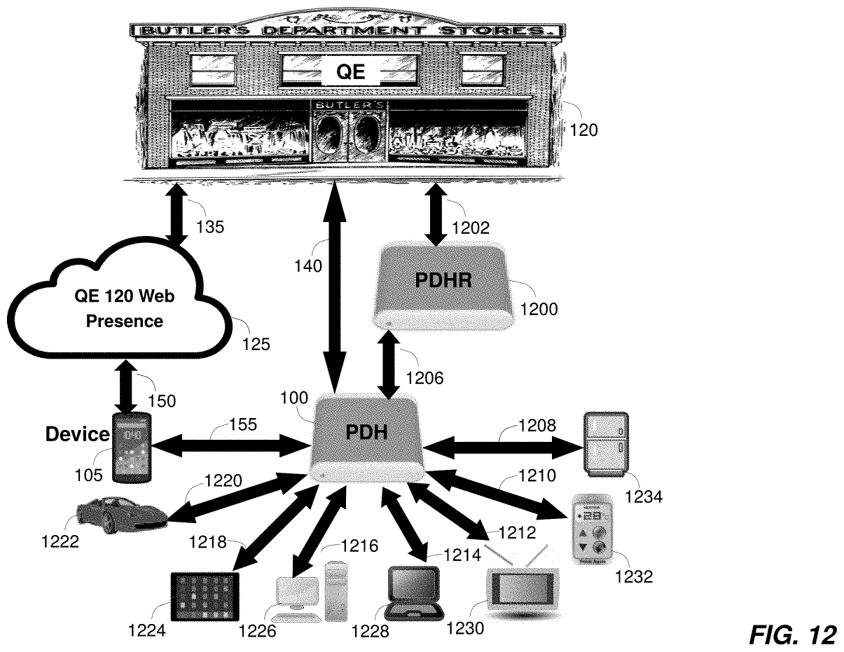

FIG. 12 illustrates an embodiment of the second system approach of the present invention. The components comprising this embodiment include PDH 100, Device 105, QE 120, and Personal Data Hub Registry, PDHR 1200. FIG. 3 is a block diagram that depicts the components comprising an embodiment of PDH 100, an embodiment of a Personal Data Hub of the present invention. In the second system approach, network connected Device 105 communicates to PDH 100 data related to the individual who uses Device 105 over Line 155. Network Communications Interface (NCI) 300 of FIG. 3 controlled by Data Acquisition Code Module (DACM) 334 executing on Computer Processor Unit (CPU) 310 then receives the communicated data from Device 105 and stores the data in Data Storage Unit (DSU) 316, specifically in Device Data Storage 322. Data Inference Profile Code Module (DIPCM) 340 executing on CPU 310 causes CPU 310 to retrieve data related to the individual who uses Device 105 from Device Data Storage 322 and generate processed data comprised of an inference or profile of characteristics that relates to the individual from all or part of the retrieved stored data and store the processed data in DSU 316, specifically in Generated Inference or Profile Of Characteristics Data Storage 326. Following the generation of processed data by DIPCM 340, data related to the characteristics of the processed data generated by DIPCM 340 may be generated by QEICM 342 executing on CPU 310 and stored along with the processed data in Generated Inference or Profile Of Characteristics Data Storage 326. In addition, Encryption Decryption Code Module (EDCM) 348 executing on CPU 310 may be used to cause CPU 310 to generate PDH 100's public/private encryption key pair and store the key pair in DSU 316, specifically in Public/Private Key Data Storage 364.

Both a network address that can be used to establish network communication with PDH 100 and Application Program Interface (API) protocols that can be used to interact with PDH 100 may be installed in PDH 100 by the manufacturer of PDH 100 at the time of PDH 100 manufacture. In the embodiment of the second system approach being discussed, the network address is stored in Personal Data Hub Network Address Data Storage 362 and the API protocols are stored in Application Program Interface Protocol Storage 332. A code module executing on CPU 310 may be included in PDH 100 that periodically queries a server maintained by the manufacturer of PDH 100, or a third party, by use of NCI 300, to obtain alternative network addresses that can be used to interact with PDH 100, or upgrades to API protocols used by PDH 100, This code module may also update the network addresses stored in Personal Data Hub Network Address Data Storage 362 or the API protocols stored in Application Program Interface Protocol Storage 332. The PDHC of PDH 100 may also manually obtain alternative network addresses or API protocol upgrades and direct CPU 310 to update the network addresses or API protocols resident in DSU 316, by use of a User Interface (UI) incorporated in Device 105.

Registry Data Exchange Interaction Code Module (RDEICM) 360 executing on CPU 310 retrieves data related to the characteristics of the processed data from Generated Inference or Profile Of Characteristics Data Storage 326, the public encryption key portion of PDH 100's public/private encryption key pair from Public/Private Key Data Storage 364, the Application Program Interface protocols that can be used to interact with PDH 100 from Application Program Interface Protocol Storage 332, and a network address that can be used to establish network communication with PDH 100 from Personal Data Hub Network Address Data Storage 362. RDEICM 360 formats the retrieved data into data elements acceptable to PDHR 1200 and communicates the data elements over Line 1206, by use of NCI 300, to PDHR 1200.

QE 120 communicates with PDHR 1200 over Line 1202 and obtains the data elements related to the characteristics of the processed data, the data elements carrying the public encryption key portion of PD 100's public/private encryption key pair, the data elements carrying the Application Program Interface protocols that may be used to interact with PDH 100, and the data elements carrying a network address that can be used to establish network communication with PDH 100 over Line 140 from PDH 100's database record. Using some or all of this information, QE 120 decides if there is an interest in being provisioned processed data from PDH 100. If QE 120 decides that there is an interest, QE 120 establishes network communication with the PDH 100 by use of the network address obtained from PDHR 1200 that can be used to establish network communication with PDH 100 and interacts with the PDH 100 by use of the PDH 100 API protocols obtained from PDHR 1200.

QE 120 may establish one-way encrypted communication with PDH 100 by encrypting information provided to PDH 100 to PDH 100's public encryption key obtained from PDHR 1200. Once one-way encrypted communication is established over Line 140 between QE 120 and PDH 100, QE 120 may securely communicate its public encryption key to PDH 100, and a network address that can be used by PDH 100 to communicate with QE 120, in addition to information needed by PDH 100's PDHC to determine if the provisioning of PDH 100 processed data to QE 120 is of interest. Two-way encrypted communication between QE 120 and PDH 100, that is encrypted communication in the second direction from PDH 100 to QE 120, may then be established over Line 140. Two-way encrypted communication is effected by PDH 100 encrypting data to be provided to QE 120 to QE 120's public encryption key prior to it being communicated to QE 120 over Line 140. If PDH 100's PDHC determines that the provisioning of PDH 100 processed data to QE 120 is of interest, QE 120 may be provisioned over Line 140, by use of NCI 300, processed data that relates to PDH 100's PDHC from PDH 100, as directed by QEICM 342 executing on CPU 310, such processed data being encrypted to QE 120's public encryption key. The data that relates to PDH 100's PDHC received from Device 105 stored in Data Storage Unit (DSU) 316 is withheld from QE 120 by QEICM 342.

FIG. 12 also illustrates an example constellation of network connected devices that may be used by the PDHC of PDH 100. Each network connected device provides data to PDH 100 related to the PDHC's use of the particular device. Data provided by a network connected device used by the PDHC is combined by PDH 100 with data from other network connected devices used by the PDHC, and used to generate processed data. Processed data may be in the form of inferences or profiles of characteristics related to the PDHC. The processed data may then be provisioned by PDH 100 to QE 120 over Line 140. As shown, example devices used by the PDHC of PDH 100 include: Device 105, a smart phone; Device 1222, a smart car; Device 1224, a tablet computer; Device 1226, a desk top computer; Device 1228, a laptop computer; Device 1230, a smart television; Device 1232, a smart thermostat; and Device 1234, a smart refrigerator. In FIG. 12, Device 105 is shown in communication with QE 120 Web Presence 125 over Line 150, although any smart network connected device used by the PDHC of PDH 100 may serve in place of Device 105. During communication with QE 120 Web Presence 125 over Line 150, Device 105 may communicate the PDH 100 PDH Identifier communicated to Device 105 from PDH 100 over Line 155 by MMCM 346 executing on CPU 310 by use of NCI 300. By QE 120 monitoring Web Presence 125 over Line 135 and comparing the PDH 100 PDH Identifier communicated over Line 150 to Web Presence 125 by Device 105 with the PDH Identifier incorporated in PDH 100 processed data communicated over Line 140 to QE 120 by PDH 100, QE 120 can determine if PDH 100's PDHC is most likely in communication with QE 120 Web Presence 125.

In a third system approach for: first making QE 120 aware of the existence and network presence of PDH 100; second, providing QE 120 with data related to the characteristics of the processed data available from PDH 100; and third, establishing a private network connection between QE 120 and PDH 100, a network API gateway, to be referred to in this discussion as a Personal Data Hub Registry and Data Exchange or PDHRDE, replaces the PDHR. In the third system approach, the PDHRDE serves as both a network service registry and a conduit for exchanging data between a plurality of PDHs and a QE. As a registry, a PDHRDE duplicates the functionality of a PDHR. However, as a conduit for exchanging data a PDHRDE prevents a QE from accessing all the fields of registered PDH database records. In particular, the PDHRDE prevents a QE from accessing an IP address that can be used by a QE to directly communicate with a registered PDH. Therefore in the third system approach, all data communicated between PDH 100 and QE 120 passes through the PDHRDE and thus the PDHRDE serves as the communications link between QE 120 and PDH 100. This allows the network location of PDH 100 to remain unknown to QE 120.

Prior to a PDHRDE serving as the communications link between QE 120 and PDH 100, PDH 100 establishes network communication with the PDHRDE and registers with the PDHRDE. Such registration can be effected by PDH 100, using publicly known PDHRDE IP addresses or URLs, along with published PDHRDE Application Program Interface protocols, at the time PDH 100 connects to a network, the Internet for example. PDHRDE IP addresses or URLs, and PDHRDE Application Program Interface protocols of a number of PDHRDEs may also be incorporated in PDH 100 at the time of PDH 100 manufacture by the manufacturer of PDH 100. PDH 100 may also be periodically updated with new PDHRDE IP addresses or URLs, and PDHRDE Application Program Interface protocols by the manufacture of PDH 100 or a third party service. As is the case for the second approach, PDH 100's PDHC may choose to direct outgoing communication to a PDHRDE and incoming communication from a PDHRDE, through a proxy server.

The process of registration comprises communicating data elements that carry five groups of data from a PDH to a PDHRDE. The first group are data elements that serve as a header. This header indicates that following data elements emanate from a PDH. The second group are data elements that carry data related to the characteristics of the processed data available from the registering PDH. The third group are data elements that carry the public encryption key of the PDH. The fourth group are data elements that carry the Application Program Interface protocols that can be used to interact with the PDH. The fifth group are data elements that carry an IP address that can be used to establish network communication with the PDH. As is the case for the second approach, in the third system approach the five groups of data elements from PDH 100, except for the header, may be encrypted to the public key of the PDHRDE to which PDH 100 is registered. PDH 100 may obtain the public key of the PDHRDE from a public key server, or, by using publicly available PDHRDE IP Addresses or URLs from a supplementary information source, directly from the PDHRDE. PDH 100 may also be provided with the public key of one or more PDHRDEs at the time of manufacture by PDH 100's manufacturer. Additionally, PDH 100 may be periodically updated with new public keys by either accessing a PDHRDE public key repository maintained by PDH 100's manufacturer, or a public key server maintained by a third party.

Once PDH 100 is registered with a PDHRDE, the PDHRDE decrypts the encrypted groups of data elements received from PDH 100 using its private key, and may incorporate the unencrypted groups of data elements into a database record. Such a database record may equate the data elements in the second group of data elements communicated to the PDHRDE from PDH 100 that carry data related to the characteristics of the processed data available from PDH 100, with the data elements in the third group of data elements communicated to the PDHRDE from PDH 100 that carry the public encryption key of PDH 100, with the data elements in the fourth group of data elements communicated to the PDHRDE from PDH 100 that carry the Application Program Interface protocols that can be used to interact with PDH 100, with the data elements in the fifth group of data elements communicated to the PDHRDE from PDH 100 that carry the IP address that can be used to establish network communication with PDH 100. QE 120 may access a PDHRDE hosting the database record of PDH 100, using publicly known PDHRDE IP addresses or URLs, and PDHRDE published access protocols, and review the database record associated with PDH 100, as well as the database records associated with other PDHs. This review may be facilitated by the PDHRDE providing a search engine, for example, a “Structured Query Language” or SQL search engine, though other search engines may be employed, that allows QE 120 to search unrestricted fields of PDH database records and obtain a listing of PDHs that offer processed data of interest to QE 120. However, unlike the second approach, fields of the database record that carry data elements that provide information allowing QE 120 to directly communicate with PDH 100, such as PDH 100's IP address, will not be available to QE 120.

If after reviewing PDH 100's database record QE 120 has an interest in being provisioned processed data from PDH 100, QE 120 may interact with the PDHRDE on which PDH 100's database record is hosted and request access to PDH 100. QE 120 may indicate its interest in PDH 100 access by use of a PDH 100 apparatus designator obtained from the PDHRDE. The apparatus designator may, for example, be a string of alphanumeric characters generated by the PDHRDE, or PDH 100's public encryption key incorporated in PDH 100's database record. Once access to PDH 100 is effected by the PDHRDE establishing network communication with the PDH 100 by use of the IP address incorporated in PDH 100's database record that can be used to establish network communication with PDH 100, QE 120 may interact with PDH 100 through the PDHRDE by use of the PDH 100 Application Program Interface protocols incorporated in PDH 100's database record.

With all communication between QE 120 and PDH 100 passing through the PDHRDE, it is important to assure that the PDHRDE does not have access to the data passed between PDH 100 and QE 120. This distances the operators of the PDHRDE from all data communicated between a PDH 100 and QE 120, and makes the PDHRDE less subject to privacy regulations in force in the jurisdictions in which PDH 100 and QE 120 operate. To this end, data passed through the PDHRDE to PDH 100 from QE 120 may be encrypted to PDH 100's public encryption key by QE 120, QE 120 having access to PDH 100's public encryption key from PDH 100's PDHRDE database record, and data passed through the PDHRDE to QE 120 from PDH 100 may be encrypted to QE 120's public encryption key by PDH 100, QE 120's public encryption key being communicated to the PDHRDE by QE 120 and passed through to PDH 100 by the PDHRDE once interaction between QE 120 and PDH 100 is initiated. Thereafter, QE 120 may communicate information to PDH 100 needed by the PDH 100's PDHC to determine if the provisioning of PDH 100 processed data to QE 120 is of interest encrypted to PDH 100's public encryption key through the PDHRDE, and PDH 100 may communicate processed data to QE 120 encrypted to QE 120's public encryption key through the PDHRDE, without the PDHRDE having access to the data. Once a secure communication channel through the PDHRDE is in place, and PDH 100's PDHC determines that provisioning of PDH 100 processed data to QE 120 is of interest, PDH 100 may provision to QE 120 through the PDHRDE processed data that relates to PDH 100's PDHC encrypted to QE 120's public encryption key.

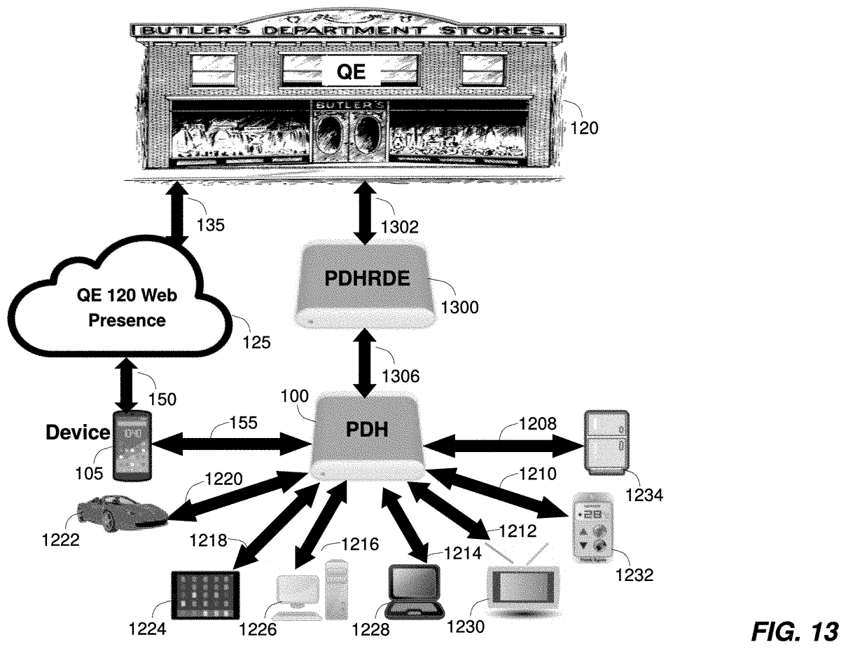

FIG. 13 illustrates an embodiment of the third system approach of the present invention. The components comprising this embodiment include PDH 100, Device 105, QE 120, and Personal Data Hub Registry, PDHRDE 1300. FIG. 3 is a block diagram that depicts the components comprising an embodiment of PDH 100, an embodiment of a Personal Data Hub of the present invention. In the third system approach, network connected Device 105 communicates to PDH 100 data related to the individual who uses Device 105 over Line 155. Network Communications Interface (NCI) 300 of FIG. 3 controlled by Data Acquisition Code Module (DACM) 334 executing on Computer Processor Unit (CPU) 310 then receives the communicated data from Device 105 and stores the data in Data Storage Unit (DSU) 316, specifically in Device Data Storage 322. Data Inference Profile Code Module (DIPCM) 340 executing on CPU 310 causes CPU 310 to retrieve data related to the individual who uses Device 105 from Device Data Storage 322 and generate processed data comprised of an inference or profile of characteristics that relates to the individual from all or part of the retrieved stored data and store the processed data in DSU 316, specifically in Generated Inference or Profile Of Characteristics Data Storage 326. Following the generation of processed data by DIPCM 340, data related to the characteristics of the processed data generated by DIPCM 340 may be generated by QEICM 342 executing on CPU 310 and stored along with the processed data in Generated Inference or Profile Of Characteristics Data Storage 326. In addition, Encryption Decryption Code Module (EDCM) 348 executing on CPU 310 may be used to cause CPU 310 to generate PDH 100's public/private encryption key pair and store the key pair in DSU 316, specifically in Public/Private Key Data Storage 364.

Both a network address that can be used to establish network communication with PDH 100 and Application Program Interface (API) protocols that can be used to interact with PDH 100 may be installed in PDH 100 by the manufacturer of PDH 100 at the time of PDH 100 manufacture. In the embodiment of the third system approach being discussed, the network address is stored in Personal Data Hub Network Address Data Storage 362 and the API protocols are stored in Application Program Interface Protocol Storage 332. A code module executing on CPU 310 may be included in PDH 100 that periodically queries a server maintained by the manufacturer of PDH 100, or a third party, by use of NCI 300, to obtain alternative network addresses that can be used to interact with PDH 100, or upgrades to API protocols used by PDH 100, This code module may also update the network addresses stored in Personal Data Hub Network Address Data Storage 362 or the API protocols stored in Application Program Interface Protocol Storage 332. The PDHC of PDH 100 may also manually obtain alternative network addresses or API protocol upgrades and direct CPU 310 to update the network addresses or API protocols resident in DSU 316, by use of a User Interface (UI) incorporated in Device 105.

Registry Data Exchange Interaction Code Module (RDEICM) 360 executing on CPU 310 retrieves data related to the characteristics of the processed data from Generated Inference or Profile Of Characteristics Data Storage 326, the public encryption key portion of PDH 100's public/private encryption key pair from Public/Private Key Data Storage 364, the Application Program Interface protocols that can be used to interact with PDH 100 from Application Program Interface Protocol Storage 332, and a network address that can be used to establish network communication with PDH 100 from Personal Data Hub Network Address Data Storage 362. RDEICM 360 formats the retrieved data into data elements acceptable to PDHRDE 1300 and communicates the data elements over Line 1306, by use of NCI 300, to PDHRDE 1300.

QE 120 communicates with PDHRDE 1300 over Line 1302 and obtains the data elements related to the characteristics of processed data available from PDH 100, the data elements carrying the public encryption key portion of PD 100's public/private encryption key pair, and the data elements carrying the Application Program Interface protocols that may be used to interact with PDH 100, from PDH 100's database record hosted on PDHRDE 1300. Using some or all of this information, QE 120 decides if there is an interest in being provisioned processed data from PDH 100 through PDHRDE 1300. If QE 120 decides that there is an interest, QE 120 may request PDHRDE 1300 to establish communication with PDH 100 by use of a PDH 100 apparatus designator, so it may access PDH 100. In the embodiment of the present invention under discussion, QE 120 may use PDH 100's public encryption key as the designator. In response to QE 120, PDHRDE 1300 establishes network communication with PDH 100 over Line 1306 by use of the network address obtained from PDH 100 that can be used to establish network communication with PDH 100. After PDHRDE 1300 establishes network communication with PDH 100 over Line 1306, QE 120 interacts with PDH 100 through the PDHRDE 1300 over Line 1302 by use of the Application Program Interface protocols obtained from PDHRDE 1300 that can be used to interact with PDH 100.

In order for PDH 100 to be able to communicate encrypted data to QE 120 through PDHRDE 1300 over Lines 1302 and 1306, QE 120 provides its public encryption key to PDH 100 through the PDHRDE 1300 over Lines 1306 and 1302. QE 120 also communicates information related to QE 120 to PDH 100 encrypted to PDH 100's public encryption key through PDHRDE 1300 over Lines 1302 and 1306, PDH 100's public encryption key having been obtained by QE 120 from PDH 100's database record hosted on PDHRDE 1300. After PDH 100's PDHC reviews the information related to QE 120 received from QE 120 through PDHRDE 1300 over Lines 1302 and 1306, QE 120 may be provisioned processed data from PDH 100 that relates to PDH 100's PDHC through PDHRDE 1300 over lines 1306 and 1302, the processed data being encrypted to QE 120's public encryption key. PDH 100's RDEICM 360 executing on CPU 310 by use of NCI 300 effects the provisioning of processed data to QE 120 through PDHRDE 1300 over Lines 1306 and 1302. The data that relates to PDH 100's PDHC received from Device 105 stored in Data Storage Unit (DSU) 316 is withheld from QE 120 by RDEICM 360.

FIG. 13 also illustrates an example constellation of network connected devices that may be used by the PDHC of PDH 100. Each network connected device provides data to PDH 100 related to the PDHC's use of the particular device. Data provided by a network connected device used by the PDHC is combined by PDH 100 with data from other network connected devices used by the PDHC, and used to generate processed data. Processed data may be in the form of inferences or profiles of characteristics related to the PDHC. The processed data may then be provisioned by PDH 100 to QE 120 through PDHRDE 1300 over Lines 1306 and 1302. As shown, example devices used by the PDHC of PDH 100 include: Device 105, a smart phone; Device 1222, a smart car; Device 1224, a tablet computer; Device 1226, a desk top computer; Device 1228, a laptop computer; Device 1230, a smart television; Device 1232, a smart thermostat; and Device 1234, a smart refrigerator. In FIG. 13, Device 105 is shown in communication with QE 120 Web Presence 125 over Line 150, although any smart network connected device used by the PDHC of PDH 100 may serve in place of Device 105. During communication with QE 120 Web Presence 125 over Line 150, Device 105 may communicate the PDH 100 PDH Identifier communicated to Device 105 from PDH 100 over Line 155 by MMCM 346 executing on CPU 310 by use of NCI 300. By QE 120 monitoring Web Presence 125 over Line 135 and comparing the PDH 100 PDH Identifier communicated over Line 150 to Web Presence 125 by Device 105 with the PDH Identifier incorporated in PDH 100 processed data communicated through PDHRDE 1300 over Lines 1306 and 1302 to QE 120 by PDH 100, QE 120 can determine if PDH 100's PDHC is most likely in communication with QE 120 Web Presence 125.

Having thus described several aspects of an embodiment of the present invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for provisioning processed data to an entity comprising:
a network connected device used by an individual, the device comprising:
a Device Computer Processor Unit;
a Device Data Storage Unit;
a Device Network Communication Interface; and
a Device Information Display capable of displaying information visually, acoustically, or tactually to the individual, or accepting information from the individual visually, acoustically, or tactually; and
a network connected apparatus controlled by the individual, the apparatus comprising:
an Apparatus Computer Processor Unit;
an Apparatus Data Storage Unit; and
an Apparatus Network Communication Interface;
wherein:
a Device Application Program stored in the Device Storage Unit executing on the Device Computer Processor Unit, causes the Device Network Communication Interface to communicate to the apparatus data related to the individual who uses the device, the Apparatus Network Communication Interface of the apparatus receives the data, the Apparatus Network Communication Interface being controlled by a Code Module executing on the Apparatus Computer Processor Unit, and a Code Module executing on the Apparatus Computer Processor Unit causes the Apparatus Computer Processor Unit to store the received data in the Apparatus Data Storage Unit;
a Code Module executing on the Apparatus Computer Processor Unit causes the Apparatus Computer Processor Unit to generate processed data comprised of an inference or profile of characteristics that relates to the individual from the stored data or portions thereof;
a Code Module executing on the Apparatus Computer Processor Unit causes the Apparatus Computer Processor to prepare information to be presented to the individual by use of the Device Application Program and the Device Information Display that relates to the processed data or the entity, and to accept information or commands from the individual by use of the Device Application Program and the Device Information Display that relates to the processed data or the entity;
a Code Module executing on the Apparatus Computer Processor Unit causes the Apparatus Computer Processor Unit to communicate the information to the Device Application Program by use of the Apparatus Network Communication Interface;
the Device Application Program executing on the Device Computer Processor Unit presents the information to the individual or accepts information or commands from the individual by use of the Device Information Display;
the Device Application Program executing on the Device Computer Processor Unit communicates a command to the Apparatus Computer Processor Unit by use of the Device Network Communication Interface, such command accepted from the individual by use of the Device Information Display;
a Code Module executing on the Apparatus Computer Processor Unit causes the Apparatus Computer Processor Unit to receive from the device used by the individual by use of the Apparatus Network Communication Interface, the command, such command being to select the generated processed data that relates to the individual for provisioning to the entity;
a Code Module executing on the Apparatus Computer Processor Unit causes the Apparatus Computer Processor Unit to select for provisioning to the entity the generated processed data that relates to the individual commanded to be provisioned to the entity by the individual; and
a Code Module executing on the Apparatus Computer Processor Unit causes the Apparatus Computer Processor Unit to provision to the entity, by use of the Apparatus Network Communication Interface, the selected processed data that relates to the individual.

2. The system of claim 1 wherein a Code Module executing on the Apparatus Computer Processor Unit causes the Apparatus Computer Processor Unit to mark the selected processed data that relates to the individual with an apparatus identifier and a Code Module executing on the Apparatus Computer Processor Unit causes the Apparatus Computer Processor Unit to communicate the apparatus identifier to the network connected device used by the individual by use of the Apparatus Network Communications Interface.

3. The system of claim 2 wherein the Device Application Program executing on the the Device Computer Processor Unit of the network connected device used by the individual causes the Device Network Communication Interface of the network connected device used by the individual to communicate the apparatus identifier to a network address owned, controlled, used, or accessed by the entity.

4. The system of claim 1 wherein the Code Module executing on the Apparatus Computer Processor Unit that causes the Apparatus Computer Processor Unit to generate processed data that relates to the individual from the stored data or portion thereof is downloaded to the apparatus from the entity.

5. The system of claim 1 wherein a Code Module executing on the Apparatus Computer Processor Unit causes the Apparatus Computer Processor Unit to communicate the selected processed data that relates to the individual to the entity through the Apparatus Network Communications Interface when an event is detected.

6. The system of claim 5 wherein the event is defined by the entity.

7. The system of claim 1 wherein the individual who uses the network connected device from which the network connected apparatus receives data related to the individual is the individual who controls the provisioning of the processed data from the network connected apparatus to the entity.

8. The system of claim 1 wherein a Code Module executing on the Apparatus Computer Processor Unit causes the Apparatus Computer Processor Unit to combine data acquired from two or more network connected devices used by the individual and store the combined data in the Apparatus Data Storage Unit.

9. The system of claim 1 wherein a Code Module executing on the Apparatus Computer Processor Unit causes the Apparatus Computer Processor Unit to withhold from the entity the received data from the network connected device used by the individual, such data stored in the Apparatus Data Storage Unit.

10. A system for provisioning processed data to an entity comprising:
a network connected device used by an individual, the device comprising:
a Device Computer Processor Unit;
a Device Data Storage Unit; and
a Device Network Communication Interface; and
a network connected apparatus controlled by the individual, the apparatus comprising:
an Apparatus Computer Processor Unit;
an Apparatus Data Storage Unit; and
an Apparatus Network Communication Interface;
wherein:
a Device Application Program stored in the Device Storage Unit executing on the Device Computer Processor Unit, causes the Device Network Communication Interface to communicate to the apparatus data related to the individual who uses the device, the Apparatus Network Communication Interface of the apparatus receives the data, the Apparatus Network Communication Interface being controlled by a Code Module executing on the Apparatus Computer Processor Unit, and a Code Module executing on the Apparatus Computer Processor Unit causes the Apparatus Computer Processor Unit to store the received data in the Apparatus Data Storage Unit;
a Code Module executing on the Apparatus Computer Processor Unit causes the Apparatus Computer Processor Unit to generate processed data comprised of an inference or profile of characteristics that relates to the individual from data retrieved from the Apparatus Data Storage Unit or portions thereof;
a Code Module executing on the Apparatus Computer Processor Unit causes the Apparatus Computer Processor Unit to generate data related to characteristics of the processed data;
a Code Module executing on the Apparatus causes the Apparatus Computer Processor Unit to generate an Apparatus public/private encryption key pair;
a Code Module executing on the Apparatus causes the Apparatus Computer Processor Unit to generate data elements carrying Application Program Interface protocols that can be used to interact with the Apparatus;
a Code Module executing on the Apparatus causes the Apparatus Computer Processor Unit to generate data elements carrying a network address that can be used to establish network communication with the Apparatus;
a Code Module executing on the Apparatus Computer Processor Unit causes the Apparatus Computer Processor Unit to communicate the data elements related to the characteristics of the processed data, the data elements carrying the public encryption key portion of the apparatus public/private encryption key pair, the data elements carrying the Application Program Interface protocols that can be used to interact with the apparatus, and the data elements carrying a network address that can be used to establish network communication with the apparatus, to a network service registry by use of the Apparatus Network Communication Interface;
the entity communicates with the network service registry and obtains the data elements related to the characteristics of the processed data, the data elements carrying the public encryption key portion of the apparatus public/private encryption key pair, the data elements carrying the Application Program Interface protocols that may be used to interact with the apparatus, and the data elements carrying a network address that can be used to establish network communication with the apparatus;
the entity establishes network communication with the apparatus by use of the network address obtained from the service registry that can be used to establish network communication with the apparatus;
the entity interacts with the apparatus by use of the Application Program Interface protocols obtained from the service registry;
the entity provides its public encryption key to the apparatus;
the entity communicates information to the apparatus encrypted to the public encryption key portion of the apparatus public/private encryption key pair; and
the entity receives processed data from the apparatus encrypted to the entity's public encryption key by use of a Code Module executing on the Apparatus Computer Processor Unit that causes the Apparatus Computer Processor Unit to provision to the entity, by use of the Apparatus Network Communication Interface, the processed data.

11. The system of claim 10 wherein a Code Module executing on the Apparatus Computer Processor Unit causes the Apparatus Computer Processor Unit to mark the selected processed data that relates to the individual with an apparatus identifier and a Code Module executing on the Apparatus Computer Processor Unit causes the Apparatus Computer Processor Unit to communicate the apparatus identifier to the network connected device used by the individual by use of the Apparatus Network Communications Interface.

12. The system of claim 11 wherein the Device Application Program executing on the Device Computer Processor Unit of the network connected device used by the individual causes the Device Network Communication Interface of the network connected device used by the individual to communicate the apparatus identifier to a network address owned, controlled, used, or accessed by the entity.

13. The system of claim 10 wherein the network service registry hosts data from a plurality of network connected apparatuses.

14. The system of claim 10 wherein a Code Module executing on the Apparatus Computer Processor Unit causes the Apparatus Computer Processor Unit to withhold from the entity the received data from the network connected device used by the individual, such data stored in the Apparatus Data Storage Unit.

15. A system for provisioning processed data to an entity comprising:
a network connected device used by an individual, the device comprising:
a Device Computer Processor Unit;
a Device Data Storage Unit; and
a Device Network Communication Interface; and
a network connected apparatus controlled by the individual, the apparatus comprising:
an Apparatus Computer Processor Unit;
an Apparatus Data Storage Unit; and
an Apparatus Network Communication Interface;
wherein:
a Device Application Program stored in the Device Storage Unit executing on the Device Computer Processor Unit, causes the Device Network Communication Interface to communicate to the apparatus data related to the individual who uses the device, the Apparatus Network Communication Interface of the apparatus receives the data, the Apparatus Network Communication Interface being controlled by a Code Module executing on the Apparatus Computer Processor Unit, and a Code Module executing on the Apparatus Computer Processor Unit causes the Apparatus Computer Processor Unit to store the received data in the Apparatus Data Storage Unit;
a Code Module executing on the Apparatus Computer Processor Unit causes the Apparatus Computer Processor Unit to generate processed data comprised of an inference or profile of characteristics that relates to the individual from data retrieved from the Apparatus Data Storage Unit or portions thereof;
a Code Module executing on the Apparatus Computer Processor Unit causes the Apparatus Computer Processor Unit to generate data related to characteristics of the processed data;
a Code Module executing on the Apparatus causes the Apparatus Computer Processor Unit to generate an Apparatus public/private encryption key pair;
a Code Module executing on the Apparatus causes the Apparatus Computer Processor Unit to generate data elements carrying Application Program Interface protocols that can be used to interact with the Apparatus;
a Code Module executing on the Apparatus causes the Apparatus Computer Processor Unit to generate data elements carrying a network address that can be used to establish network communication with the Apparatus;
a Code Module executing on the Apparatus Computer Processor Unit causes the Apparatus Computer Processor Unit to communicate the data elements related to the characteristics of the processed data, the data elements carrying the public encryption key portion of the apparatus public/private encryption key pair, the data elements carrying the Application Program Interface protocols that can be used to interact with the apparatus, and the data elements carrying a network address that can be used to establish network communication with the apparatus, to a network API gateway by use of the Apparatus Network Communication Interface;
the entity communicates with the network API gateway and obtains the data elements related to the characteristics of the processed data, the data elements carrying the public encryption key portion of the apparatus public/private encryption key pair, and the data elements carrying the Application Program Interface protocols that may be used to interact with the apparatus;
the entity requests the network API gateway for access to the apparatus using an apparatus designator obtained from the network API gateway;
the network API gateway establishes network communication with the apparatus by use of the network address obtained from the apparatus that can be used to establish network communication with the apparatus;
the entity interacts with the apparatus through the network API gateway by use of the Application Program Interface protocols obtained from the network API gateway that can be used to interact with the apparatus;
the entity provides its public encryption key to the apparatus through the network API gateway;
the entity communicates information to the apparatus encrypted to the public encryption key portion of the apparatus public/private encryption key pair through the network API gateway; and
the entity receives processed data through the network API gateway from the apparatus encrypted to the entity's public encryption key, by use of a Code Module executing on the Apparatus Computer Processor Unit that causes the Apparatus Computer Processor Unit to provision to the entity, through the network API gateway, by use of the Apparatus Network Communication Interface, the processed data.

16. The system of claim 15 wherein the apparatus designator obtained from the network API gateway is the public encryption key of the apparatus.

17. The system of claim 15 wherein a Code Module executing on the Apparatus Computer Processor Unit causes the Apparatus Computer Processor Unit to mark the processed data that relates to the individual with an apparatus identifier and a Code Module executing on the Apparatus Computer Processor Unit causes the Apparatus Computer Processor Unit to communicate the apparatus identifier to the network connected device used by the individual by use of the Apparatus Network Communications Interface.

18. The system of claim 17 wherein the Device Application Program executing on the Device Computer Processor Unit of the network connected device used by the individual causes the Device Network Communication Interface of the network connected device used by the individual to communicate the apparatus identifier to a network address owned, controlled, used, or accessed by the entity.

19. The system of claim 15 wherein the network API gateway hosts data from a plurality of network connected apparatuses.

20. The system of claim 15 wherein a Code Module executing on the Apparatus Computer Processor Unit causes the Apparatus Computer Processor Unit to withhold from the entity the received data from the network connected device used by the individual, such data stored in the Apparatus Data Storage Unit.
